(19) United States
(12) Patent Application Publication
(10) Pub. No.: US 2023/0106766 A1
(43) Pub. Date: Apr. 6, 2023

(54) NULLING FOR INTER-USER EQUIPMENT INTERFERENCE CANCELLATION

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US); Krishna Kiran MUKKAVILLI, San Diego, CA (US); Joseph Patrick BURKE, San Diego, CA (US); Tingfang JI, San Diego, CA (US); Renqiu WANG, San Diego, CA (US); Hwan Joon KWON, San Diego, CA (US)

(21) Appl. No.: 17/450,032

(22) Filed: Oct. 5, 2021

(51) Int. Cl. H04W 72/08; H04L 5/00

(52) U.S. Cl. CPC H04W 72/082; H04L 5/0048

(57) ABSTRACT

Various aspects of the present disclosure generally relate to wireless communication. In some aspects, a first mobile station may determine at least one of a channel between the first mobile station and a second mobile station or a relative direction between the first mobile station and the second mobile station. The first mobile station may apply nulling to a communication between the first mobile station and a base station based at least in part on the at least one of the channel between the first mobile station and the second mobile station or the relative direction between the first mobile station and the second mobile station. Numerous other aspects are described.

### FIELD OF THE DISCLOSURE

Aspects of the present disclosure generally relate to wireless communication and to techniques and apparatuses for nulling for inter-user equipment (UE) interference cancellation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first mobile station for wireless communication. The first mobile station may include a memory and one or more processors coupled to the memory. The one or more processors may be configured to determine at least one of a channel between the first mobile station and a second mobile station or a relative direction between the first mobile station and the second mobile station. The one or more processors may be configured to apply nulling to a communication between the first mobile station and a base station based at least in part on the at least one of the channel between the first mobile station and the second mobile station or the relative direction between the first mobile station and the second mobile station.

Some aspects described herein relate to a base station for wireless communication. The base station may include a memory and one or more processors coupled to the memory. The one or more processors may be configured to transmit, to a first mobile station, information relating to at least one of a channel between the first mobile station and a second mobile station or a relative direction between the first mobile station and the second mobile station. The one or more processors may be configured to transmit, to the first mobile station, an indication of whether to apply nulling to a communication between the first mobile station and the base station based at least in part on the at least one of the channel between the first mobile station and the second mobile station or the relative direction between the first mobile station and the second mobile station.

Some aspects described herein relate to a method of wireless communication performed by a first mobile station. The method may include determining, by the first mobile station, at least one of a channel between the first mobile station and a second mobile station or a relative direction between the first mobile station and the second mobile station. The method may include applying, by the first mobile station, nulling to a communication between the first mobile station and a base station based at least in part on the at least one of the channel between the first mobile station and the second mobile station or the relative direction between the first mobile station and the second mobile station.

Some aspects described herein relate to a method of wireless communication performed by a base station. The method may include transmitting, by the base station and to a first mobile station, information relating to at least one of a channel between the first mobile station and a second mobile station or a relative direction between the first mobile station and the second mobile station. The method may include transmitting, by the base station and to the first mobile station, an indication of whether to apply nulling to a communication between the first mobile station and the base station based at least in part on the at least one of the channel between the first mobile station and the second mobile station or the relative direction between the first mobile station and the second mobile station.

Some aspects described herein relate to a non-transitory computer-readable medium that stores a set of instructions for wireless communication by a first mobile station. The set of instructions, when executed by one or more processors of the first mobile station, may cause the first mobile station to determine at least one of a channel between the first mobile station and a second mobile station or a relative direction between the first mobile station and the second mobile station. The set of instructions, when executed by one or more processors of the first mobile station, may cause the first mobile station to apply nulling to a communication between the first mobile station and a base station based at least in part on the at least one of the channel between the first mobile station and the second mobile station or the relative direction between the first mobile station and the second mobile station.

Some aspects described herein relate to a non-transitory computer-readable medium that stores a set of instructions for wireless communication by a base station. The set of instructions, when executed by one or more processors of the base station, may cause the base station to transmit, to a first mobile station, information relating to at least one of a channel between the first mobile station and a second mobile station or a relative direction between the first mobile station and the second mobile station. The set of instructions, when executed by one or more processors of the base station, may cause the base station to transmit, to the first mobile station, an indication of whether to apply nulling to a communication between the first mobile station and the base station based at least in part on the at least one of the channel between the first mobile station and the second mobile station or the relative direction between the first mobile station and the second mobile station.

Some aspects described herein relate to an apparatus for wireless communication. The apparatus may include means for determining at least one of a channel between the apparatus and a mobile station or a relative direction between the apparatus and the mobile station. The apparatus may include means for applying nulling to a communication between the apparatus and a base station based at least in part on the at least one of the channel between the apparatus and the mobile station or the relative direction between the apparatus and the mobile station.

Some aspects described herein relate to an apparatus for wireless communication. The apparatus may include means for transmitting, to a first mobile station, information relating to at least one of a channel between the first mobile station and a second mobile station or a relative direction between the first mobile station and the second mobile station. The apparatus may include means for transmitting, to the first mobile station, an indication of whether to apply nulling to a communication between the first mobile station and the apparatus based at least in part on the at least one of the channel between the first mobile station and the second mobile station or the relative direction between the first mobile station and the second mobile station.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of inter-UE interference, in accordance with the present disclosure.

FIG. 4 is a diagram illustrating an example associated with receive (Rx) nulling for inter-UE interference cancellation, in accordance with the present disclosure.

FIG. 5 is a diagram illustrating an example associated with transmit (Tx) nulling for inter-UE interference cancellation, in accordance with the present disclosure.

FIG. 6 is a diagram illustrating an example associated with spatial nulling for inter-UE interference cancellation, in accordance with the present disclosure.

FIGS. 7-8 are diagrams illustrating example processes associated with nulling for inter-UE interference cancellation, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

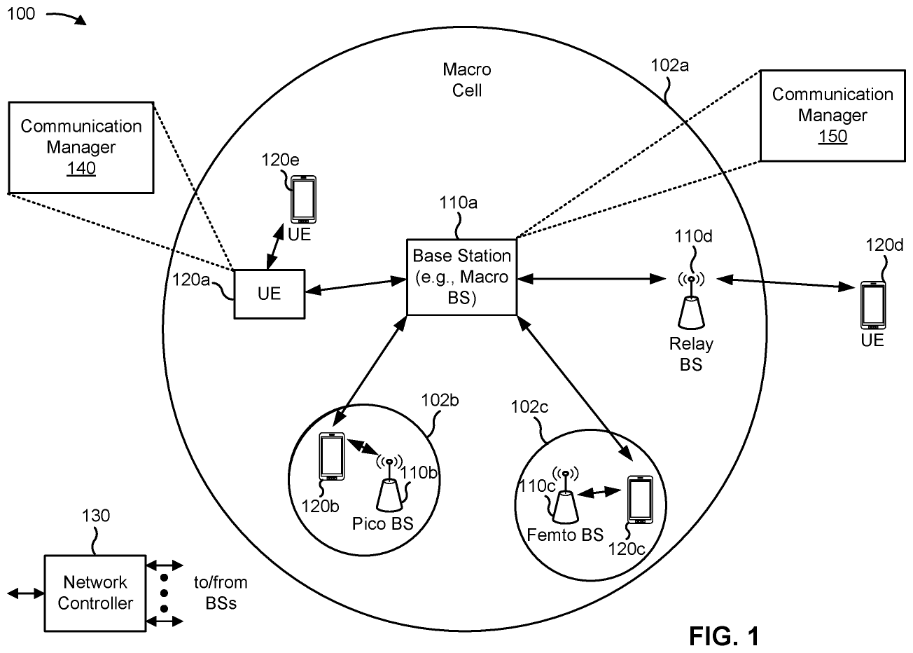

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine at least one of a channel between the UE 120 and a second mobile station (e.g., another UE) or a relative direction between the UE 120 and the second mobile station; and apply nulling to a communication between the UE 120 and a base station based at least in part on the at least one of the channel between the UE 120 and the second mobile station or the relative direction between the UE 120 and the second mobile station. Additionally, or alternatively, the communication manager 140 may perform one or more other operations described herein.

In some aspects, the base station 110 may include a communication manager 150. As described in more detail elsewhere herein, the communication manager 150 may transmit, to a first mobile station, information relating to at least one of a channel between the first mobile station and a second mobile station or a relative direction between the first mobile station and the second mobile station; and transmit, to the first mobile station, an indication of whether to apply nulling to a communication between the first mobile station and the base station based at least in part on the at least one of the channel between the first mobile station and the second mobile station or the relative direction between the first mobile station and the second mobile station. Additionally, or alternatively, the communication manager 150 may perform one or more other operations described herein.

As indicated above, FIG. 1 is provided as an example. Other examples may differ from what is described with regard to FIG. 1.

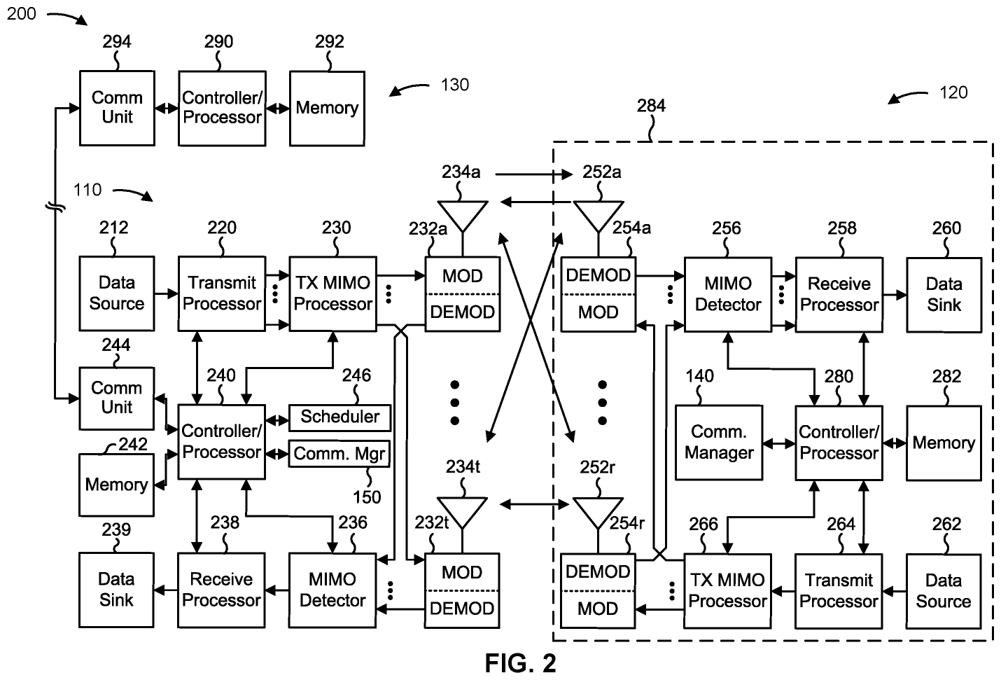

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

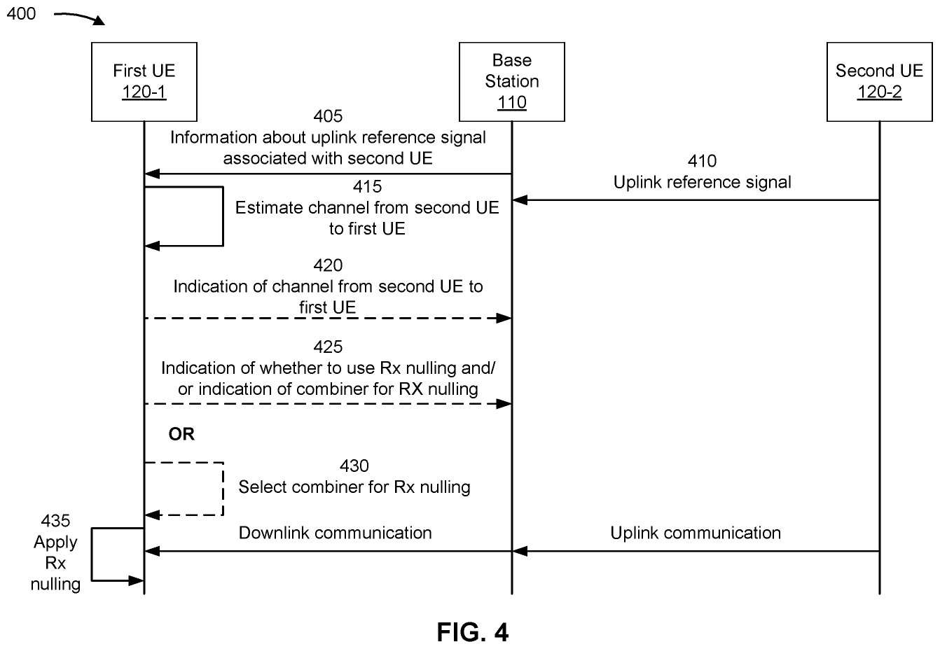

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

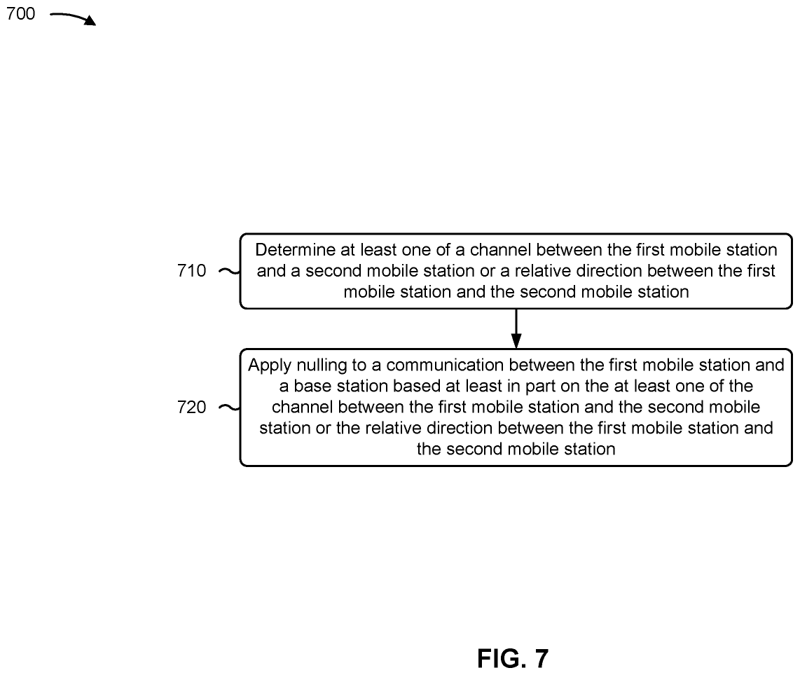

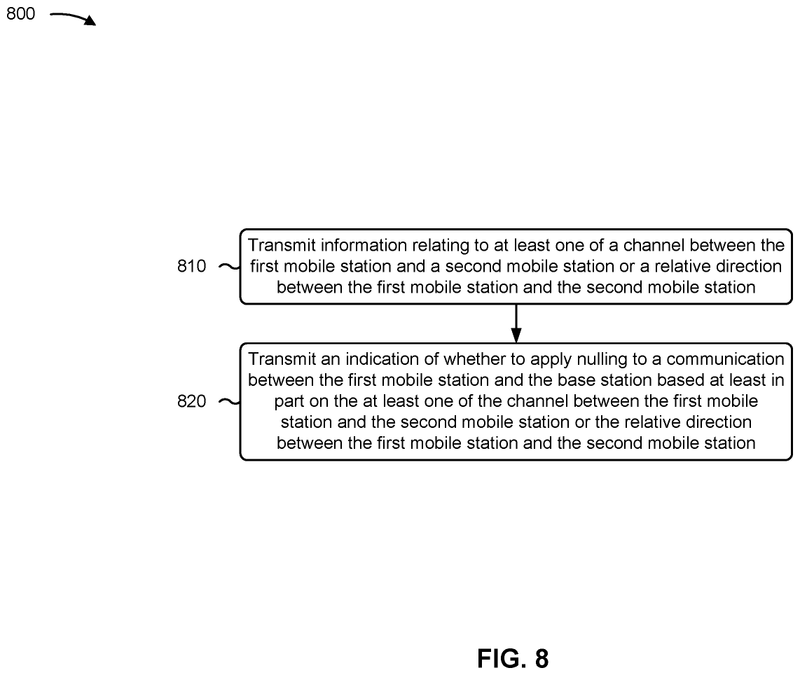

The controller/processor 240 of the base station 110, the controller/processor 280 of the UE 120, and/or any other component(s) of FIG. 2 may perform one or more techniques associated with nulling for inter-UE interference cancellation, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples. In some aspects, the mobile station described herein is the UE 120, is included in the UE 120, or includes one or more components of the UE 120 shown in FIG. 2.

In some aspects, a first mobile station includes means for determining at least one of a channel between the first mobile station and a second mobile station or a relative direction between the first mobile station and the second mobile station; and/or means for applying nulling to a communication between the first mobile station and a base station based at least in part on the at least one of the channel between the first mobile station and the second mobile station or the relative direction between the first mobile station and the second mobile station. In some aspects, the means for the first mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting, to a first mobile station, information relating to at least one of a channel between the first mobile station and a second mobile station or a relative direction between the first mobile station and the second mobile station; and/or means for transmitting, to the first mobile station, an indication of whether to apply nulling to a communication between the first mobile station and the base station based at least in part on the at least one of the channel between the first mobile station and the second mobile station or the relative direction between the first mobile station and the second mobile station. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

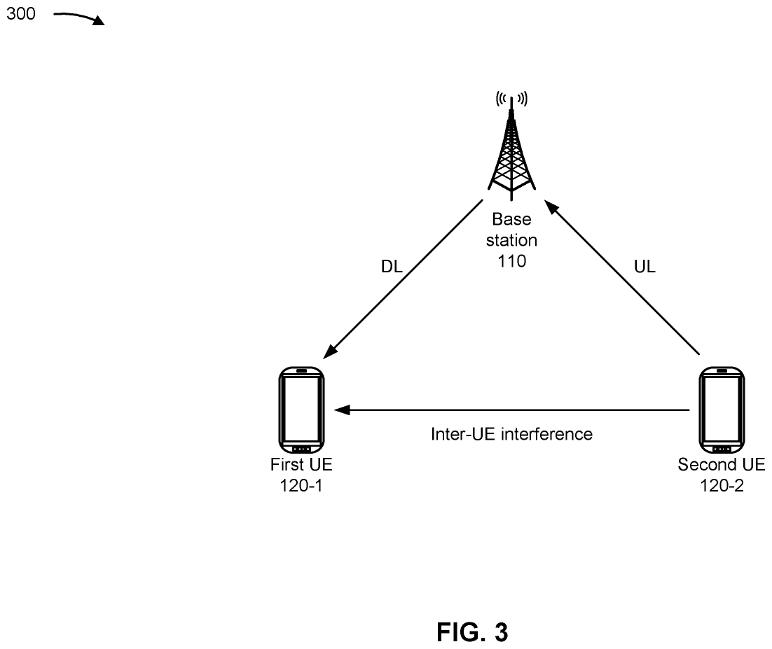

FIG. 3 is a diagram illustrating an example 300 of inter-UE interference, in accordance with the present disclosure. As shown, example 300 includes a base station 110, a first UE 120-1, and a second UE 120-2. In some examples, the base station 110 may be capable of full-duplex communication. In some examples, the first UE 120-1 and/or the second UE 120-2 may also be capable of full-duplex communication.

Full-duplex communication may include a contemporaneous uplink and downlink communication using the same resources. For example, as shown in FIG. 3, the base station 10 may transmit a downlink (DL) communication to the first UE 120-1 and may receive an uplink (UL) communication from the second UE 120-2 using the same or different frequency resources and at least partially overlapping time domain resources. In this case, the first UE 120-1, when receiving the downlink communication from the base station 110, may experience interference from the transmission of the uplink communication by the second UE 120-2. Such interference at one UE (e.g., the first UE 120-1) that is caused by a transmission from another UE (e.g., the second UE 120-2) may be referred to as “inter-UE interference.” In the case of inter-UE interference, the UE that experiences the interference (e.g., the first UE 120-1) may be referred to as a victim UE, and the UE that causes the interference (e.g., the second UE 120-2) may be referred to as the aggressor UE. Inter-UE interference may result in degradation of the signal quality of downlink communications, which may adversely affect the ability of the victim UE (e.g., the first UE 120-1) to reliably decode the downlink communications.

In some examples, in a full-duplex node (e.g., the base station 110 or a UE 120) that performs contemporaneous transmission and reception, the transmission, by the full-duplex node, may cause self-interference with the reception by the full-duplex node. In some examples, transmit (Tx) and/or receive (Rx) nulling may be used to mitigate self-interference at a full-duplex node. Tx nulling applies a precoder to a transmitted signal that results in applying nulling (e.g., transmitting a null signal) in a certain direction (e.g., on a certain channel). Rx nulling applies a combiner to a received signal that results in applying nulling (e.g., receiving a null signal) in a certain direction (e.g., on a certain channel). For example, a full-duplex node may apply Rx nulling at an Rx side of the full-duplex node and/or apply Tx nulling at a Tx side of the full-duplex mode to mitigate self-interference. Tx nulling and Rx nulling may rely on knowledge of the channel to which the nulling is applied, which may be easily found at a full-duplex node because the transmitted and the receiver are located at the same node. However, for inter-UE interference, a UE (e.g., a victim UE and/or an aggressor UE) may not have the channel knowledge to apply Rx nulling and/or Tx nulling to mitigate the inter-UE interference.

In some examples, spatial nulling may be used to mitigate inter-UE interference. Spatial nulling is nulling performed in the physical domain to reduce or prevent transmission or reception of a signal in a certain spatial direction. For example, spatial nulling may be achieved by selecting which antennas to use to transmit and/or receive a signal or by physically blocking certain signal directions (e.g., using isolators and/or reflectors, among other examples). However, spatial nulling to mitigate inter-UE interference may require knowledge of the physical locations of the UEs, with respect to each other, and the victim UE and/or the aggressor UE may not have the knowledge of the relative locations of the UEs to apply spatial nulling.

Some techniques and apparatuses described herein enable a first UE (e.g., a first mobile station) to determine a channel between the first UE and a second UE (e.g., a second mobile station) or a relative direction between the first UE and the second UE. The first UE may apply nulling to a communication between the first UE and a base station based at least in part on the channel between the first UE and the second UE or the relative direction between the first UE and the second UE. In some aspects, the first UE may determine the channel between the first UE and the second UE or the relative direction between the first UE and the second UE based at least in part on information received from the base station. In some aspects, the first UE may estimate a channel from the second UE to the first UE, and the first UE may apply Rx nulling to reception of a downlink communication based at least in part on the channel from the second UE to the first UE (e.g., to reduce inter-UE interference on the downlink communication from an uplink transmission by the second UE). In some aspects, the first UE may determine a channel from the first UE to the second UE, and the first UE may apply Tx nulling to transmission of an uplink communication based at least in part on the channel from the first UE to the second UE (e.g., to reduce inter-UE interference from the uplink communication on reception of a downlink communication by the second UE). In some aspects, the first UE may determine the relative direction between the first UE and the second UE, and the first UE may applying spatial nulling to the communication between the first UE and the base station based at least in part on the relative direction between the first UE and the second UE. As a result, the first UE may reduce inter-UE interference between the first UE and the second UE, which may result in improved reliability in receiving downlink communications by the first UE or the second UE.

As indicated above, FIG. 3 is provided as an example. Other examples may differ from what is described with respect to FIG. 3.

FIG. 4 is a diagram illustrating an example 400 associated with Rx nulling for inter-UE interference cancellation, in accordance with the present disclosure. As shown in FIG. 4, example 400 includes communication between a base station 110, a first UE 120-1, and a second UE 120-2. In some aspects, the base station 110, the first UE 120-1, and the second UE 120-2 may be included in a wireless network, such as wireless network 100. The base station 110 may communicate with the first UE 120-1 and/or the second UE 120-2 via a wireless access link, which may include an uplink and a downlink. In some aspects, the first UE 120-1 and the second UE 120-2 may communicate via a sidelink.

The first UE 120-1 may be a first mobile station, may be included in a first mobile station, or may include a first mobile station. The second UE 120-2 may be a second mobile station, may be included in a second mobile station, or may include a second mobile station. In some aspects, as shown in FIG. 4, the first UE 120-1 may be a victim UE, and the second UE 120-2 may be an aggressor UE that causes inter-UE interference on reception of a downlink communication by the victim UE (e.g., the first UE 120-1). In other aspects, the first UE 120-1 may be an aggressor UE, and the second UE may be a victim UE.

As shown in FIG. 4, and by reference number 405, the base station 110 may transmit, to the first UE 120-1, information about an uplink reference signal associated with the second UE 120-2. For example, the base station 110 may transmit, to the first UE 120-1, an indication of a configuration of the uplink reference signal associated with the second UE 120-2. The uplink reference signal may be any reference signal configured to be transmitted to the base station 110 by the second UE 120-2. For example, the uplink reference signal may be a DMRS associated with the second UE 120-2, a sounding reference signal (SRS) associated with the second UE 120-2, or an SRS for cross-link interference (CLI) (e.g., a CLI SRS) associated with the second UE 120-2. In some aspects, the base station 110 may transmit, to the first UE 120-1, an indication of a configuration for an uplink reference signal that is configured with a same frequency resource and/or a same transmission direction (e.g., beam direction) as an uplink communication (e.g., a physical uplink shared channel (PUSCH) communication) that is causing inter-UE interference with reception of a downlink communication by the first UE 120-1.

In some aspects, the base station 110 may transmit, to the first UE 120-1, an indication of time and frequency resources configured for the second UE 120-2 to transmit the uplink reference signal and sequence information associated with the uplink reference signal. For example, the sequence information may include a seed for generating the uplink reference signal sequence. In some aspects, the base station 110 may transmit, and the first UE 120-1 may receive, an indication of time and frequency resources and sequence information for a DMRS sequence configured to be transmitted to the base station 110 by the second UE 120-2. In some aspects, the base station 110 may transmit, and the first UE 120-1 may receive, an indication of an SRS configuration (e.g., including time and frequency resources and sequence information) for an SRS configured to be transmitted to the base station 110 by the second UE 120-2. In some aspects, the base station 110 may transmit, and the first UE 120-1 may receive, an indication of an SRS configuration (e.g., including time and frequency resources and sequence information) for an SRS for CLI configured to be transmit to the base station 110 by the second UE 120-2. In some aspects, the base station 110 may transmit the indication of the configuration of the uplink reference signal associated with the second UE 120-2 via a dynamic signal (e.g., in downlink control information (DCI)), a medium access control (MAC) control element (MAC-CE), or a radio resource control (RRC) configuration.

In some aspects, instead of or in addition to receiving the information about the uplink reference signal from the base station 110, the first UE 120-1 may receive the information about the uplink reference signal from the second UE 120-2. For example, the second UE 120-2 may share (e.g., transmit) an indication of a configuration for the uplink reference signal (e.g., DMRS, SRS, or CLI SRS) associated with the second UE 120-2 via a sidelink channel, and the first UE 120-1 may receive the indication of the configuration for the uplink reference signal from the second UE 120-2 via the sidelink channel.

As further shown in FIG. 4, and by reference number 410, the second UE 120-2 may transmit the uplink reference signal to the base station 110. For example, the second UE 120-2 may transmit a DMRS, an SRS, or an SRS for CLI to the base station 110.

As further shown in FIG. 4, and by reference number 415, the first UE 120-1 may estimate a channel from the second UE 120-2 to the first UE 120-1 based at least in part on the uplink reference signal transmitted by the second UE 120-2 to the base station 110. In some aspects, the first UE 120-1 may estimate the channel from the second UE 120-2 to the first UE 120-1 from the transmission of the uplink reference signal by the second UE 120-2 based at least in part on the indication of the configuration of the uplink reference signal received from the base station 110 (or from the second UE 120-2). For example, based at least in part on the time and frequency resources associated with the uplink reference signal, the first UE 120-1 may estimate the channel from the second UE 120-2 to the first UE 120-1 when the second UE 120-2 is transmitting the uplink reference signal to the base station 110. That is, the first UE 120-1 (e.g., the victim UE) may estimate the channel from the second UE 120-2 (e.g., the aggressor UE) to the first UE 120-1 (e.g., the victim UE) when the second UE 120-2 (e.g., the aggressor UE) is transmitting a signal in the direction of the base station 110, in order to estimate the channel associated with inter-UE interference from an uplink transmission by the second UE 120-2 (e.g., the aggressor UE).

In some aspects, the first UE 120-1 may detect a received signal at the first UE 120-1 when the second UE 120-2 transmits the uplink reference signal to the base station 110. For example, the first UE 120-1 may detect the received signal in the time and frequency resources configured for transmission of the uplink reference signal by the second UE 120-2. The first UE 120-1 may generate the uplink reference signal sequence transmitted by the second UE 120-2 using the sequence information (e.g., the seed for generating the sequence) associated with the uplink reference signal. In some aspects, the first UE 120-1 may estimate the channel from the second UE 120-2 to the first UE 120-1 by estimating a channel coefficient (e.g., a channel coefficient matrix) that results in the received signal when applied to the transmitted uplink signal sequence. For example, the first UE 120-1 may estimate the channel coefficient (e.g., the channel coefficient matrix) by dividing the received signal by the generated uplink reference signal sequence associated with the uplink reference signal that is transmitted by the second UE 120-2.

In some aspects, the first UE 120-1 may estimate the channel from the second UE 120-2 to the first UE 120-1 using a DMRS transmitted by the second UE 120-2 to the base station 110. In some aspects, the first UE 120-1 may estimate the channel from the second UE 120-2 to the first UE 120-1 using an SRS transmitted by the second UE 120-2 to the base station 110. In some aspects, the first UE 120-1 may estimate the channel from the second UE 120-2 to the first UE 120-1 using an SRS for CLI (e.g., a CLI SRS) transmitted by the second UE 120-2 to the base station 110. In some aspects, the uplink reference signal used by the first UE 120-1 to estimate the channel from the second UE 120-2 to the first UE 120-1 may be configured with a same frequency resource and/or a same transmission direction (e.g., beam direction) as an uplink communication that causes (or has previously caused) inter-UE interference with reception of a downlink communication by the first UE 120-1.

As further shown in FIG. 4, and by reference number 420, in some aspects, the first UE 120-1 may transmit, to the base station 110 an indication of the channel from the second UE 120-2 to the first UE 120-1. For example, once the first UE 120-1 estimates the channel from the second UE 120-2 to the first UE 120-1, the first UE 120-1 may transmit the indication of the estimated channel to the base station 110. In some aspects, the first UE 120-1 may transmit, to the base station 110, an indication of the estimated channel coefficient (e.g., channel coefficient matrix) for the channel from the second UE 120-2 to the first UE 120-1. For example, the first UE 120-1 may transmit the indication of the estimated channel to the base station 110 via a MAC-CE or an RRC message.

In some aspects, the first UE 120-1 may transmit the indication of the estimated channel (e.g., the channel from the second UE 120-2 to the first UE 120-1) to the second UE 120-2. For example, the first UE 120-1 may transmit the indication of the estimated channel to the second UE 120-2 to be used by the second UE 120-2 for Tx nulling, as described elsewhere herein. In some aspects, the base station 110 may receive the indication of the estimated channel (e.g., the channel from the second UE 120-2 to the first UE 120-1) from the first UE 120-1, and the base station 110 may transmit the indication of the estimated channel to the second UE 120-2. For example, the base station 110 may transmit the indication of the estimated channel to the second UE 120-2 to be used by the second UE 120-2 for Tx nulling, as described elsewhere herein.

As further shown in FIG. 4, and by reference number 425, in some aspects, the base station 110 may transmit, to the first UE 120-1, an indication of whether to use Rx nulling and/or an indication of a combiner for applying Rx nulling. In some cases, Rx nulling, by the first UE 120-1, may impact the reception of a downlink communication transmitted to the first UE 120-1. For example, based at least in part on the estimated channel from the second UE 120-2 and the first UE 120-1, applying Rx nulling during reception of a downlink communication may, in some cases, reduce the strength of the received downlink signal as well as the inter-UE interference from an uplink communication transmitted by the second UE 120-2. In some aspects, the base station 110, based at least in part on the indication of the estimated channel (e.g., the channel from the second UE 120-2 to the first UE 120-1) received from the first UE 120-1, may determine whether the first UE 120-1 is to apply Rx nulling for reception of a downlink communication. For example, the base station 110 may determine whether the first UE 120-1 is to apply Rx nulling based at least in part on predicted impact of Rx nulling for the estimated channel on the downlink communication to be transmitted to the first UE 120-1. In some aspects, the base station 110 may indicate, to the first UE 120-1, whether to use Rx nulling or not. For example, the base station 110 may transmit, to the first UE 120-1, a one bit indication of whether to use Rx nulling or not for a scheduled downlink communication. In some aspects, the base station 110 may transmit the indication of whether to use Rx nulling to the first UE 120-1 via DCI, a MAC-CE, or an RRC message.

In some aspects, the base station 110 may determine a combiner to be used by the first UE 120-1 to apply Rx nulling to reception of a scheduled downlink communication. The combiner may include one or more combiner parameters for combining signals received by the first UE 120-1 (e.g., signals received by antennas of the first UE 120-1). In some aspects, the base station 110 may select the combiner to be used by the first UE 120-1, based at least in part on the estimated channel from the second UE 120-2 to the first UE 120-1, to apply Rx nulling to reduce (or cancel) inter-UE interference received on the estimated channel. For example, the base station 110 may estimate combiner parameters that maximize the signal to interference plus noise ratio (SINR) for the reception of the downlink communication by maximizing the downlink signal received on the channel from the base station 110 to the first UE 120-1 and minimizing the signal (e.g., interference) received on the channel from the second UE 120-2 to the first UE 120-1. In some aspects, the base station 110 may transmit, to the first UE 120-1, an indication of the combiner (e.g., one or more combiner parameters) to be used by the first UE 120-1 for Rx nulling. For example, the base station 110 may transmit the indication of the combiner for Rx nulling to the first UE 120-1 via DCI, a MAC-CE, or an RRC message. In some aspects, the base station 110 may transmit the indication of the combiner to the first UE 120-1 in addition to, or instead of, transmitting the indication of whether to perform Rx nulling.

As further shown in FIG. 4, and by reference number 430, in some aspects, the first UE 120-1 may select the combiner for Rx nulling based at least in part on the estimated channel from the second UE 120-2 to the first UE 120-1. In some aspects, instead of receiving an indication of the combiner (e.g., the combiner parameters) from the base station 110, the first UE 120-1 may autonomously select the combiner based at least in part on the estimated channel from the second UE 120-2 to the first UE 120-1. For example, the first UE 120-1 may select a combiner (e.g., one or more combiner parameters) that maximizes the SINR of a scheduled downlink communication by maximizing the downlink signal received on the channel from the base station 110 to the first UE 120-1 and minimizing the signal (e.g., interference) received on the estimated channel from the second UE 120-2 to the first UE 120-1. In some aspects, the first UE 120-1 may select the combiner based at least in part on receiving the indication to apply Rx nulling from the base station 110. In some aspects, the first UE 120-1 may autonomously select the combiner regardless of whether the first UE 120-1 receives the indication to apply Rx nulling from the base station 110.

As further shown in FIG. 4, and by reference number 435, the first UE 120-1 may apply Rx nulling to reception of a downlink communication from the base station 110. In some aspects, the base station 110 may transmit the downlink communication to the first UE 120-1, and the second UE 120-2 may transmit an uplink communication to the base station 110. For example, the downlink communication and the uplink communication may be transmitted at the same time or in overlapping time domain resources. The first UE 120-1 may apply Rx nulling to reception of the downlink communication using the combiner (e.g., the one or more combiner parameters) indicated by the base station 110 or selected by the first UE 120-1. For example, the first UE 120-1 may apply the combiner to digitally filter signals received (e.g., by antennas of the first UE 120-1) in the time and frequency resources allocated for the downlink communication to reduce interference received on the channel from the second UE 120-2 to the first UE 120-1 from the transmission of the uplink communication by the second UE 120-2. In some aspects, the first UE 120-1 may apply the Rx nulling to the reception of the downlink communication based at least in part on receiving the indication to apply Rx nulling from the base station 110.

In some aspects, the Rx nulling applied by the first UE 120-1 (e.g., the victim UE) may be used together with Tx nulling applied by the second UE 120-2 (e.g., the aggressor UE) and/or spatial nulling applied by the first UE 120-1 and/or the second UE 120-2, as described elsewhere herein.

As described herein above, the first UE 120-1 may receive, from the base station 110, information about an uplink reference signal associated with the second UE 120-2. The first UE 120-1 may estimate a channel from the second UE 120-2 to the first UE 120-1 based at least in part on a transmission of the uplink reference signal by the second UE 120-2, the first UE 120-1 may apply Rx nulling to reception of a downlink communication based at least in part on the estimated channel from the second UE 120-2 to the first UE 120-1. As a result, the first UE 120-1 may reduce inter-UE interference on the downlink communication from an uplink transmission by the second UE 120-2.

As indicated above, FIG. 4 is provided as an example. Other examples may differ from what is described with respect to FIG. 4.

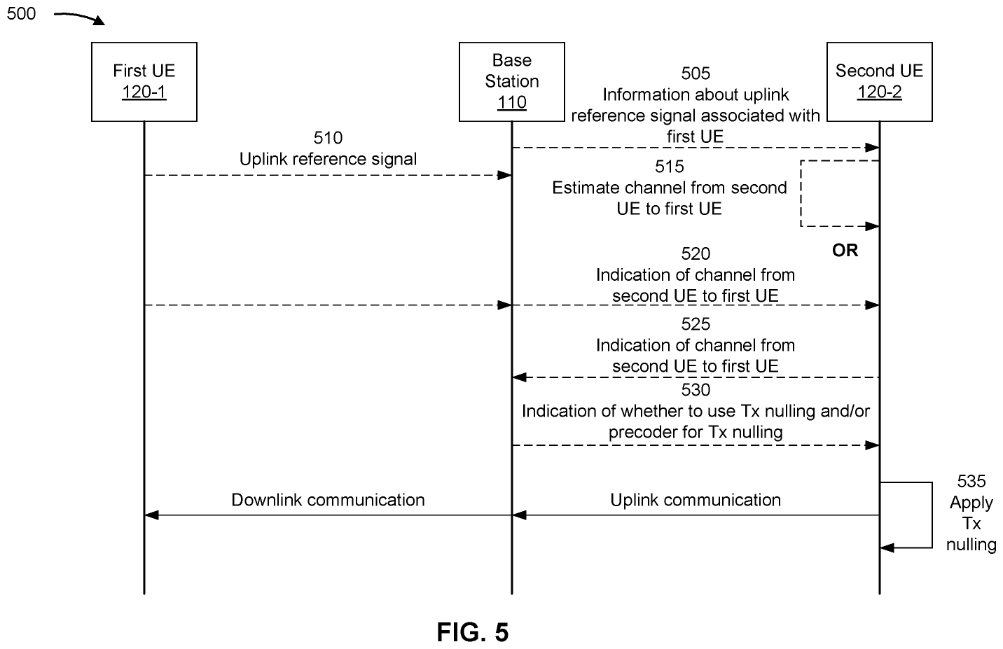

FIG. 5 is a diagram illustrating an example 500 associated with Tx nulling for inter-UE interference cancellation, in accordance with the present disclosure. As shown in FIG. 5, example 500 includes communication between a base station 110, a first UE 120-1, and a second UE 120-2. In some aspects, the base station 110, the first UE 120-1, and the second UE 120-2 may be included in a wireless network, such as wireless network 100. The base station 110 may communicate with the first UE 120-1 and/or the second UE 120-2 via a wireless access link, which may include an uplink and a downlink. In some aspects, the first UE 120-1 and the second UE 120-2 may communicate via a sidelink.

The first UE 120-1 may be a first mobile station, may be included in a first mobile station, or may include a first mobile station. The second UE 120-2 may be a second mobile station, may be included in a second mobile station, or may include a second mobile station. In some aspects, as shown in FIG. 5, the first UE 120-1 may be a victim UE and the second UE 120-2 may be an aggressor UE that causes inter-UE interference on reception of a downlink communication by the victim UE (e.g., the first UE 120-1). In other aspects, the first UE 120-1 may be an aggressor UE and the second UE may be a victim UE.

As shown in FIG. 5, and by reference number 505, in some aspects, the base station 110 may transmit, to the second UE 120-2, information about an uplink reference signal associated with the first UE 120-1. For example, the base station 110 may transmit, to the second UE 120-2, an indication of a configuration of the uplink reference signal associated with the first UE 120-1. The uplink reference signal may be any reference signal configured to be transmitted to the base station 110 by the first UE 120-1. For example, the uplink reference signal may be a DMRS associated with the first UE 120-1, an SRS associated with the first UE 120-1, or an SRS for CLI (e.g., a CLI SRS) associated with the first UE 120-1.

In some aspects, the base station 110 may transmit, to the second UE 120-2, an indication of time and frequency resources configured for the first UE 120-1 to transmit the uplink reference signal and sequence information associated with the uplink reference signal. For example, the sequence information may include a seed for generating the uplink reference signal sequence. In some aspects, the base station 110 may transmit, and the second UE 120-2 may receive, an indication of time and frequency resources and sequence information for a DMRS sequence configured to be transmitted to the base station 110 by the first UE 120-1. In some aspects, the base station 110 may transmit, and the second UE 120-2 may receive, an indication of an SRS configuration (e.g., including time and frequency resources and sequence information) for an SRS configured to be transmitted to the base station 110 by the first UE 120-1. In some aspects, the base station 110 may transmit, and the second UE 120-2 may receive, an indication of an SRS configuration (e.g., including time and frequency resources and sequence information) for an SRS for CLI configured to be transmit to the base station 110 by the first UE 120-1. In some aspects, the base station 110 may transmit the indication of the configuration of the uplink reference signal associated with the first UE 120-1 via a dynamic signal (e.g., in DCI), a MAC-CE, or an RRC configuration.

In some aspects, instead of or in addition to receiving the information about the uplink reference signal from the base station 110, the second UE 120-2 may receive the information about the uplink reference signal from the first UE 120-1. For example, the first UE 120-1 may share (e.g., transmit) an indication of a configuration for the uplink reference signal (e.g., DMRS, SRS, or CLI SRS) associated with the first UE 120-1 via a sidelink channel, and the second UE 120-2 may receive the indication of the configuration for the uplink reference signal from the first UE 120-1 via the sidelink channel.

As further shown in FIG. 5, and by reference number 510, the first UE 120-1 may transmit the uplink reference signal to the base station 110. For example, the first UE 120-1 may transmit a DMRS, an SRS, or an SRS for CLI to the base station 110.

As further shown in FIG. 5, and by reference number 515, the second UE 120-2 may estimate a channel from the second UE 120-2 to the first UE 120-1 based at least in part on the uplink reference signal transmitted by the first UE 120-1 to the base station 110. In some aspects, the second UE 120-2 may estimate a channel from the first UE 120-1 to the second UE 120-2 from the transmission of the uplink reference signal by the first UE 120-1, and the second UE 120-2 may estimate the channel from the second UE 120-2 to the first UE 120-1 based at least in part on channel reciprocity between the first UE 120-1 and the second UE 120-2. For example, in a case in which channel reciprocity exists between the first UE 120-1 and the second UE 120-2, the channel from the second UE 120-2 to the first UE 120-1 may be the same as the channel from the first UE 120-1 to the second UE 120-2. In some aspects, the second UE 120-2 may estimate that the channel from the second UE 120-2 to the first UE 120-1 is the same as the estimated channel from the first UE 120-1 to the second UE 120-2 and based at least in part on an assumption that channel reciprocity is satisfied or based at least in part on a determination that a channel reciprocity condition is satisfied.

In some aspects, the second UE 120-2 may estimate the channel from the first UE 120-1 to the second UE 120-2 from the transmission of the uplink reference signal by the first UE 120-1 based at least in part on the indication of the configuration of the uplink reference signal received from the base station 110 (or from the first UE 120-1). In some aspects, the second UE 120-2 may detect a received signal at the second UE 120-2 when the first UE 120-1 transmits the uplink reference signal to the base station 110. For example, the second UE 120-2 may detect the received signal in the time and frequency resources configured for transmission of the uplink reference signal by the first UE 120-1. The second UE 120-2 may generate the uplink reference signal sequence transmitted by the first UE 120-1 using the sequence information (e.g., the seed for generating the sequence) associated with the uplink reference signal. In some aspects, the second UE 120-2 may estimate the channel from the first UE 120-1 to the second UE 120-2 by estimating a channel coefficient (e.g., a channel coefficient matrix) that results in the received signal when applied to the transmitted uplink reference signal sequence. For example, the second UE 120-2 may estimate the channel coefficient (e.g., the channel coefficient matrix) by dividing the received signal by the generated uplink reference signal sequence associated with the uplink reference signal transmitted by the first UE 120-1.

As further shown in FIG. 5, and by reference number 520, in some aspects, the second UE 120-2 may receive, from the first UE 120-1 or from the base station 110, an indication of the channel from the second UE 120-2 to the first UE 120-1. In some aspects, the second UE 120-2 may receive the indication of the channel from the second UE 120-2 to the first UE 120-1 instead of, or in addition to, estimating the channel from the second UE 120-2 to the first UE 120-1 from the uplink reference signal transmitted by the first UE 120-1 based at least in part on channel reciprocity. For example, the second UE 120-2 may utilize a closed loop feedback to estimate the channel from the second UE 120-2 to the first UE 120-1 in connection with an assumption that channel reciprocity between the first UE 120-1 and the second UE 120-2 is not satisfied or based at least in part on a determination that a channel reciprocity condition is not satisfied. In this case, the second UE 120-2 may transmit an uplink reference signal (e.g., a DMRS, an SRS, or an SRS for CLI) to the base station 110, and the first UE 120-1 may estimate the channel from the second UE 120-2 to the first UE 120-1 from the uplink reference signal transmitted by the second UE 120-2 (e.g., based at least in part on information about the uplink reference signal received from the base station 110 or the second UE 120-2), as described above in connection with FIG. 4. In some aspects, the first UE 120-1 may transmit an indication of the estimated channel (e.g., the channel from the second UE 120-2 to the first UE 120-1) to the second UE 120-2 via a sidelink channel. In some aspects, the first UE 120-1 may transmit the indication of the estimated channel (e.g., the channel from the second UE 120-2 to the first UE 120-1) to the base station 110, and the base station 110 may transmit the indication of the estimated channel to the second UE 120-2. For example, the indication of the estimated channel from the second UE 120-2 to the first UE 120-1 may include an indication of the estimated channel coefficient (e.g., the channel coefficient matrix).

As further shown in FIG. 5, and by reference number 525, in some aspects, the second UE 120-2 may transmit, to the base station 110, an indication of the channel from the second UE 120-2 to the first UE 120-1. In some aspects, the second UE 120-2 may transmit the indication of the channel from the second UE 120-2 to the first UE 120-1 in connection with the second UE 120-2 estimating the channel from the second UE 120-2 to the first UE 120-1 (e.g., based at least in part on the uplink reference signal transmitted by the first UE 120-1). For example, once the second UE 120-2 estimates the channel from the second UE 120-2 to the first UE 120-1, the first UE 120-1 may transmit the indication of the estimated channel to the base station 110. In some aspects, the indication of the estimated channel may include an indication of the estimated channel coefficient (e.g., the channel coefficient matrix) for the channel from the second UE 120-2 to the first UE 120-1. In some aspects, the second UE 120-2 may transmit the indication of the channel from the second UE 120-2 to the first UE 120-1 in connection with the second UE 120-2 receiving the indication of the estimated channel via a sidelink communication from the first UE 120-1.

In some aspects, the base station 110 may receive the indication of the estimated channel (e.g., the channel from the second UE 120-2 to the first UE 120-1) from the first UE 120-1. For example, the first UE 120-1 may transmit the indication of the estimated channel to the base station 110 in connection with the second UE 120-2 estimating the channel from the second UE 120-2 to the first UE 120-1 (e.g., based at least in part on an uplink reference signal transmitted by the second UE 120-2). As described above, in this case, the second UE 120-2 may receive the indication of the estimated channel from the base station 110. In some aspects, the second UE 120-2 may not transmit the indication of the estimated channel to the base station 110 in a case in which the second UE 120-2 receives the indication of the estimated channel from the base station 110.

As further shown in FIG. 5, and by reference number 530, in some aspects, the base station 110 may transmit, to the second UE 120-2, an indication of whether to use Tx nulling and/or an indication of a precoder (e.g., a precoding matrix) for applying Tx nulling to an uplink transmission. In some aspects, the base station 110 may transmit the, to the second UE 120-2, the indication of whether to use Tx nulling and/or the indication of the precoder for applying Tx nulling based at least in part on receiving the indication of the estimated channel from the second UE 120-2 or the first UE 120-1. In some cases, Tx nulling, by the second UE 120-2, may impact the transmission of an uplink communication by second UE 120-2. For example, based at least in part on the estimated channel from the second UE 120-2 and the first UE 120-1, applying Tx nulling during transmission of the uplink communication may, in some cases, reduce the strength of the transmitted uplink signal on the channel from the second UE 120-2 to the base station 110 as well as the inter-UE interference from the uplink communication on the channel from the second UE 120-2 to the first UE 120-1.

In some aspects, the base station 110, based at least in part on the indication of the estimated channel (e.g., the channel from the second UE 120-2 to the first UE 120-1) received from the second UE 120-2 or the first UE 120-1, may determine whether the second UE 120-2 is to apply Tx nulling to transmission of an uplink communication. For example, the base station 110 may determine whether the second UE 120-2 is to apply Tx nulling based at least in part on a predicted impact of Tx nulling for the estimated channel on the uplink communication to be transmitted from the second UE 120-2 to the base station 110 (e.g., a predicted signal strength of the uplink communication resulting from applying the Tx nulling). In some aspects, the base station 110 may indicate, to the second UE 120-2, whether to use Tx nulling or not. For example, the base station 110 may transmit, to the second UE 120-2, a one bit indication of whether to use Tx nulling or not for a scheduled uplink communication. In some aspects, the base station 110 may transmit the indication of whether to use Tx nulling to the second UE 120-2 via DCI, a MAC-CE, or an RRC message.

In some aspects, the base station 110 may determine a precoder (e.g., a precoding matrix) to be used by the second UE 120-2 to apply Tx nulling to transmission of a scheduled uplink communication. The precoder may include one or more precoding parameters that control the amplitudes and phases of the signals transmitted from the transmit antennas of the second UE 120-2. In some aspects, the base station 110 may select the precoder to be used by the second UE 120-2, based at least in part on the estimated channel from the second UE 120-2 to the first UE 120-1, to apply Tx nulling to reduce (or cancel) a signal (e.g., inter-UE interference) transmitted on the estimated channel. For example, the base station 110 may estimate a precoder (e.g., a precoding matrix) that minimizes transmission power on the channel from the second UE 120-2 to the first UE 120-1 while maintaining at least a threshold transmission power for the uplink communication on the channel from the second UE 120-2 to the base station 110. In some aspects, the base station 110 may transmit, to the second UE 120-2, an indication of the precoder (e.g., the precoding matrix) to be used by the second UE 120-2 for Tx nulling. For example, the base station 110 may transmit the indication of the precoder for Tx nulling to the second UE 120-2 via DCI, a MAC-CE, or an RRC message. In some aspects, the base station 110 may transmit the indication of the precoder to the second UE 120-2 in addition to, or instead of, transmitting the indication of whether to perform Tx nulling.

In some aspects, instead of receiving the indication of the precoder from the base station 110, the second UE 120-2 may autonomously select the precoder based at least in part on the estimated channel from the second UE 120-2 to the first UE 120-1. For example, the second UE 120-2 may select a precoder (e.g., a precoding matrix) that minimizes transmission power, for a scheduled uplink communication, on the estimated channel from the second UE 120-2 to the first UE 120-1 and maintains at least a threshold transmission power, for the scheduled uplink communication, on the channel from the second UE 120-2 to the base station 110. In some aspects, the second UE 120-2 may select the combiner based at least in part on receiving the indication to apply Tx nulling from the base station 110.

As further shown in FIG. 5, and by reference number 535, the second UE 120-2 may apply Tx nulling to transmission of an uplink communication to the base station 110. In some aspects, the second UE 120-2 may transmit the uplink communication to the base station 110, and the base station 110 may transmit a downlink communication to the first UE 120-1. For example, the downlink communication and the uplink communication may be transmitted at the same time or in overlapping time domain resources. The second UE 120-2 may apply Tx nulling to the transmission of the uplink communication using the precoder (e.g., the precoding matrix) indicated by the base station 110 (or selected by the second UE 120-2). For example, the second UE 120-2 may apply the precoder to control signals transmitted (e.g., by transmit antennas of the second UE 120-2) in the time and frequency resources allocated for the uplink communication to reduce interference from the transmission of uplink communication on reception of the downlink communication by the first UE 120-1 (e.g., to reduce interference from the transmission on the uplink communication transmitted on the channel from the second UE 120-2 to the first UE 120-1). In some aspects, the second UE 120-2 may apply the Tx nulling to the transmission of the uplink communication based at least in part on receiving the indication to apply Tx nulling from the base station 110.

In some aspects, the Tx nulling applied by the second UE 120-2 (e.g., the aggressor UE) may be used together with Rx nulling applied by the first UE 120-1 (e.g., the victim UE) and/or spatial nulling applied by the first UE 120-1 and/or the second UE 120-2, as described elsewhere herein.

As described herein above, the second UE 120-2 may estimate a channel from the second UE 120-2 to the first UE 120-1 based at least in part on a transmission of the uplink reference signal by the first UE 120-1, or the second UE 120-2 may receive, from the first UE 120-1 or the base station 110, an indication of the channel from the second UE 120-2 to the first UE 120-1. The second UE 120-2 may apply Tx nulling to transmission of an uplink communication based at least in part on the estimated channel from the second UE 120-2 to the first UE 120-1. As a result, the second UE 120-2 may reduce inter-UE interference from the uplink transmission on reception of a downlink communication by the first UE 120-1.

As indicated above, FIG. 5 is provided as an example. Other examples may differ from what is described with respect to FIG. 5.

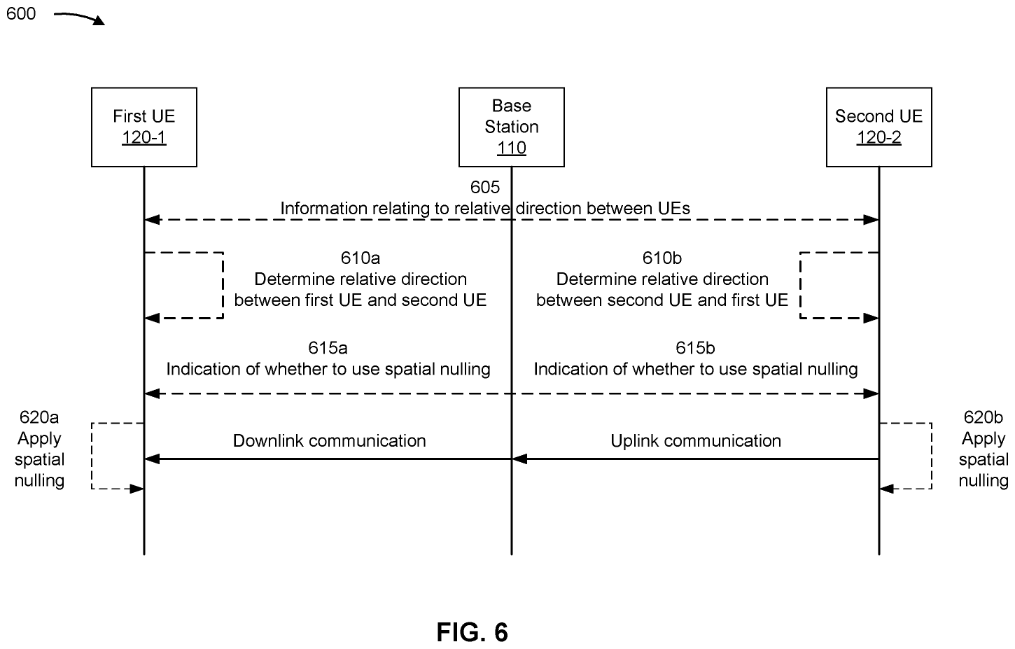

FIG. 6 is a diagram illustrating an example 600 associated with spatial nulling for inter-UE interference cancellation, in accordance with the present disclosure. As shown in FIG. 6, example 600 includes communication between a base station 110, a first UE 120-1, and a second UE 120-2. In some aspects, the base station 110, the first UE 120-1, and the second UE 120-2 may be included in a wireless network, such as wireless network 100. The base station 110 may communicate with the first UE 120-1 and/or the second UE 120-2 via a wireless access link, which may include an uplink and a downlink. In some aspects, the first UE 120-1 and the second UE 120-2 may communicate via a sidelink.

The first UE 120-1 may be a first mobile station, may be included in a first mobile station, or may include a first mobile station. The second UE 120-2 may be a second mobile station, may be included in a second mobile station, or may include a second mobile station. In some aspects, as shown in FIG. 6, the first UE 120-1 may be a victim UE and the second UE 120-2 may be an aggressor UE that causes inter-UE interference on reception of a downlink communication by the victim UE (e.g., the first UE 120-1). In other aspects, the first UE 120-1 may be an aggressor UE and the second UE may be a victim UE.

As shown in FIG. 6, and by reference number 605, the first UE 120-1 and/or the second UE 120-2 may receive information relating to a relative direction between the first UE 120-1 and the second UE 120-2. In some aspects, the base station 110 may transmit, to the first UE 120-1 and/or the second UE 120-2, the information relating to the relative direction between the first UE 120-1 and the second UE 120-2. In some aspects, the information transmitted by the base station 110 may include information to be used by the first UE 120-1 and/or the second UE 120-2 to determine the relative direction between the first UE 120-1 and the second UE 120-2. For example, the information may allow the first UE 120-1 and/or the second UE 120-2 to determine or estimate an angle of arrival (AoA) between the first UE 120-1 and the second UE 120-2.

In some aspects, the information transmitted by the base station 110 may include information about a positioning reference signal (PRS) or an SRS for positioning (e.g., a positioning SRS) associated with the second UE 120-2 and/or information about a PRS or a positioning SRS associated with the first UE 120-1. For example, the base station 110 may transmit, to the first UE 120-1, an indication of a configuration of the PRS or the positioning SRS associated with the second UE 120-2. Additionally, or alternatively, the base station 110 may transmit, to the second UE 120-2, an indication of a configuration of the PRS or the positioning SRS associated with the first UE 120-1.

In some aspects, the base station 110 may transmit a location of the second UE 120-2 to the first UE 120-1, and/or the base station 110 may transmit a location of the first UE 120-1 to the second UE 120-2. In some aspects, instead of transmitting exact locations of the first UE 120-1 and the second UE 120-2 (e.g., due to privacy concerns), the base station 110 may transmit, to the first UE 120-1 (e.g., the victim UE), a range of angles from which interference may be coming with respect to the first UE 120-1 (e.g., a range of angles for the relative direction of the second UE 120-2 with respect to the first UE 120-1). Additionally, or alternatively, the base station 110 may transmit, to the second UE 120-2 (e.g., the aggressor UE), a range of angles that may be affected by interference from an uplink transmission by the second UE 120-2 (e.g., a range of angles for the relative direction of the first UE 120-1 with respect to the second UE 120-2).

In some aspects, the information relating to the relative direction between the first UE 120-1 and the second UE 120-2 may be transmitted between the first UE 120-1 and the second UE 120-2 via a sidelink channel. In some aspects, the first UE 120-1 may transmit, via a sidelink channel, an indication of a location of the first UE 120-1, and the second UE 120-2 may receive the indication via the sidelink channel. For example, the indication of the location of the first UE 120-1 may be an indication of a relative location of the first UE 120-1, such as a location of the first UE 120-1 with respect to the base station 110. Additionally, or alternatively, the second UE 120-2 may transmit, via a sidelink channel, an indication of a location of the second UE 120-2, and the first UE 120-1 may receive the indication via the sidelink channel. For example, the indication of the location of the second UE 120-2 may be an indication of a relative location of the second UE 120-2, such as a location of the second UE 120-2 with respect to the base station 110.

As further shown in FIG. 6, and by reference number 610a, in some aspects, the first UE 120-1 may determine the relative direction between the first UE 120-1 and the second UE 120-2. In some aspects, the first UE 120-1 may determine the relative direction between the first UE 120-1 and the second UE 120-2 based at least in part on the information received from the base station 110. In some aspects, the first UE 120-1 may receive from the base station 110, an indication of a configuration of a PRS or a positioning SRS associated with the second UE 120-2. In this case, the first UE 120-1 may detect the relative direction between the first UE 120-1 and the second UE 120-2 based at least in part on the PRS or the positioning SRS associated with the second UE 120-2. In some aspects, the first UE 120-1 may receive an indication of the location of the second UE 120-2 and/or the relative direction between the first UE 120-1 and the second UE 120-2 (e.g., the range of angles from which the interference may be coming with respect to the first UE 120-1).

In some aspects, the first UE 120-1 may determine the relative direction between the first UE 120-1 and the second UE 120-2 based at least in part on the information received from the second UE 120-2 via a sidelink channel. For example, the first UE 120-1 may receive, from the second UE 120-2, an indication of a relative location of the second UE 120-2, such as a relative location of the second UE 120-2 with respect to the base station 110. In this case, the first UE 120-1 may determine the relative direction between the first UE 120-1 based at least in part on a relative location of the first UE 120-1 with respect to the base station 110 and the indicated relative location of the second UE 120-2 with respect to the base station 110.

In some aspects, the first UE 120-1 may determine the relative direction between the first UE 120-1 and the second UE 120-2 by detecting the location of the second UE 120-2 using sidelink positioning. In some aspects, the first UE 120-1 may detect the relative direction between the first UE 120-1 and the second UE 120-2 by estimating a direction of the interference, received at the first UE 120-1, from any signal transmitted by the second UE 120-2.

As further shown in FIG. 6, and by reference number 610b, in some aspects, the second UE 120-2 may determine the relative direction between the first UE 120-1 and the second UE 120-2. In some aspects, the second UE 120-2 may determine the relative direction between the first UE 120-1 and the second UE 120-2 based at least in part on the information received from the base station 110. In some aspects, the second UE 120-2 may receive from the base station 110, an indication of a configuration of a PRS or a positioning SRS associated with the first UE 120-1. In this case, the second UE 120-2 may detect the relative direction between the first UE 120-1 and the second UE 120-2 based at least in part on the PRS or the positioning SRS associated with the first UE 120-1. In some aspects, the second UE 120-2 may receive an indication of the location of the first UE 120-1 and/or the relative direction between the first UE 120-1 and the second UE 120-2 (e.g., the range of angles that may be affected by interference from the second UE 120-2).

In some aspects, the second UE 120-2 may determine the relative direction between the first UE 120-1 and the second UE 120-2 based at least in part on the information received from the first UE 120-1 via a sidelink channel. For example, the second UE 120-2 may receive, from the first UE 120-1, an indication of a relative location of the first UE 120-1, such as a relative location of the first UE 120-1 with respect to the base station 110. In this case, the second UE 120-2 may determine the relative direction between the first UE 120-1 based at least in part on a relative location of the second UE 120-2 with respect to the base station 110 and the indicated relative location of the first UE 120-1 with respect to the base station 110.

In some aspects, the second UE 120-2 may determine the relative direction between the first UE 120-1 and the second UE 120-2 by detecting the location of the first UE 120-1 using sidelink positioning. In some aspects, the first UE 120-1 may detect the relative direction between the first UE 120-1 and the second UE 120-2 by estimating a direction of the interference, received at the second UE 120-2, from any signal transmitted by the first UE 120-1.

As further shown in FIG. 6, and by reference number 615a, the base station 110 may transmit, to the first UE 120-1, an indication of whether to use spatial nulling. In some cases, spatial nulling, by the first UE 120-1, may impact the reception of a downlink communication transmitted to the first UE 120-1. For example, based at least in part on the relative direction between the first UE 120-1 and the second UE 120-2 and the relative direction between the first UE 120-1 and the base station 110, applying spatial nulling during reception of a downlink communication may, in some cases, fully or partially block the downlink signal from the base station 110, as well as the inter-UE interference from an uplink communication transmitted by the second UE 120-2. In some aspects, the base station 110, based at least in part on the direction of the downlink signal (e.g., the relative direction between first UE 120-1 and the base station 110) and the direction of the spatial nulling (e.g., the relative direction between the first UE 120-1 and the second UE 120-2), may determine whether the first UE 120-1 is to apply spatial nulling to reception of a downlink communication. For example, the base station 110 may determine whether the first UE 120-1 is to apply spatial nulling based at least in part on a prediction of whether the downlink communication will be blocked (e.g., fully or partially) by the spatial nulling. In some aspects, the base station 110 may indicate, to the first UE 120-1, whether to use spatial nulling or not. For example, the base station 110 may transmit, to the first UE 120-1, a one bit indication of whether to use spatial nulling or not for a scheduled downlink communication. In some aspects, the base station 110 may transmit the indication of whether to use spatial nulling to the first UE 120-1 via DCI, a MAC-CE, or an RRC message.

As further shown in FIG. 6, and by reference number 615b, the base station 110 may transmit, to the second UE 120-2, an indication of whether to use spatial nulling. In some cases, spatial nulling, by the second UE 120-2, may impact the transmission of an uplink communication by the second UE 120-2. For example, based at least in part on the relative direction between the first UE 120-1 and the second UE 120-2 and the relative direction between the base station 110 and the second UE 120-2, applying spatial nulling during transmission of an uplink communication may, in some cases, fully or partially block the transmission of the uplink communication to the base station 110, as well as the inter-UE interference on the first UE 120-1 from the transmission uplink communication. In some aspects, the base station 110, based at least in part on the direction of the uplink signal (e.g., the relative direction between the base station 110 and the second UE 120-2) and the direction of the spatial nulling (e.g., the relative direction between the first UE 120-1 and the second UE 120-2), may determine whether the second UE 120-2 is to apply spatial nulling to transmission of the uplink communication. For example, the base station 110 may determine whether the second UE 120-2 is to apply spatial nulling based at least in part on a prediction of whether the uplink communication to the base station 110 will be blocked (e.g., fully or partially) by the spatial nulling. In some aspects, the base station 110 may indicate, to the second UE 120-2, whether to use spatial nulling or not. For example, the base station 110 may transmit, to the second UE 120-2, a one bit indication of whether to use spatial nulling or not for a scheduled uplink communication. In some aspects, the base station 110 may transmit the indication of whether to use spatial nulling to the second UE 120-2 via DCI, a MAC-CE, or an RRC message.

As further shown in FIG. 6, and by reference number 620a, the first UE 120-1 may apply spatial nulling to reception of a downlink communication from the base station 110. For example, the first UE 120-1 may apply spatial nulling in the direction of the second UE 120-2 (e.g., in the relative direction between the first UE 120-1 and the second UE 120-2). In some aspects, the first UE 120-1 may apply the spatial nulling in the direction of the second UE 120-2 by selecting, from a set of Rx antennas, a subset of Rx antennas to use to receive the downlink communication. In this case, the antennas not included in the selected subset of antennas to use to receive the downlink communication, may include antennas that receive signals in the direction of the second UE 120-2. In some aspects, the base station 110 may transmit, to the first UE 120-1, an indication of the subset of antennas to use to apply the spatial nulling. In some aspects, the first UE 120-1 may apply the spatial nulling in the direction of the second UE 120-2 by using one or more reflectors and/or one or more isolators to block reception of signals from the direction of the second UE 120-2.

In some aspects, the base station 110 may transmit the downlink communication to the first UE 120-1, and the second UE 120-2 may transmit an uplink communication to the base station 110. For example, the downlink communication and the uplink communication may be transmitted at the same time or in overlapping time domain resources. The first UE 120-1 may apply spatial nulling in the direction of the second UE 120-2 while receiving the downlink communication to reduce interference on the downlink communication from the transmission of the uplink communication by the second UE 120-2. In some aspects, the first UE 120-1 may apply the spatial nulling to the reception of the downlink communication based at least in part on receiving the indication to apply spatial nulling from the base station 110.

As further shown in FIG. 6, and by reference number 620b, the second UE 120-2 may apply spatial nulling to transmission of the uplink communication to the base station 110. For example, the second UE 120-2 may apply spatial nulling in the direction of the first UE 120-1 (e.g., in the relative direction between the first UE 120-1 and the second UE 120-2). In some aspects, the second UE 120-2 may apply the spatial nulling in the direction of the first UE 120-1 by selecting, from a set of Tx antennas, a subset of Tx antennas to use to transmit the uplink communication. In this case, the Tx antennas not included in the selected subset of Tx antennas to use to transmit the uplink communication, may include Tx antennas that transmit in the direction of the second first UE 120-1. In some aspects, the base station 110 may transmit, to the second UE 120-2, an indication of the subset of antennas to use to apply the spatial nulling. In some aspects, the second UE 120-2 may apply the spatial nulling in the direction of the first UE 120-1 by using one or more reflectors and/or one or more isolators to block transmission of signals in the direction of the first UE 120-1.

In some aspects, the second UE 120-2 may apply spatial nulling in the direction of the first UE 120-1 while transmitting the uplink communication to reduce interference from the transmission of the uplink communication on the downlink communication to the first UE 120-1. In some aspects, the second UE 120-2 may apply the spatial nulling to the transmission of the uplink communication based at least in part on receiving the indication to apply spatial nulling from the base station 110.

In some aspects, the spatial nulling may be applied by the first UE 120-1 (e.g., the victim UE), by the second UE 120-2 (e.g., the aggressor UE), or by both the first UE 120-1 and the second UE 120-2. In some aspects, the spatial nulling by the first UE 120-1 and/or the second UE 120-2 may be used together with at least one of Rx nulling by the first UE 120-1 or Tx nulling by the second UE 120-2, as described elsewhere herein.

As described herein above, the first UE 120-1 and/or the second UE 120-2 may determine a relative direction between the first UE 120-1 and the second UE 120-2. The first UE 120-1 may apply spatial nulling to reception of a downlink communication based at least in part on the relative direction between the first UE 120-1 and the second UE 120-2, and/or the second UE 120-2 may apply spatial nulling to transmission of an uplink signal based at least in part on the relative direction between the first UE 120-1 and the second UE 120-2. As a result, inter-UE interference from an uplink transmission by the second UE 120-2 on a downlink communication to the first UE 120-1 may be reduced.

As indicated above, FIG. 6 is provided as an example. Other examples may differ from what is described with respect to FIG. 6.

FIG. 7 is a diagram illustrating an example process 700 performed, for example, by a first mobile station, in accordance with the present disclosure. Example process 700 is an example where the first mobile station (e.g., UE 120) performs operations associated with nulling for inter-UE interference cancellation.

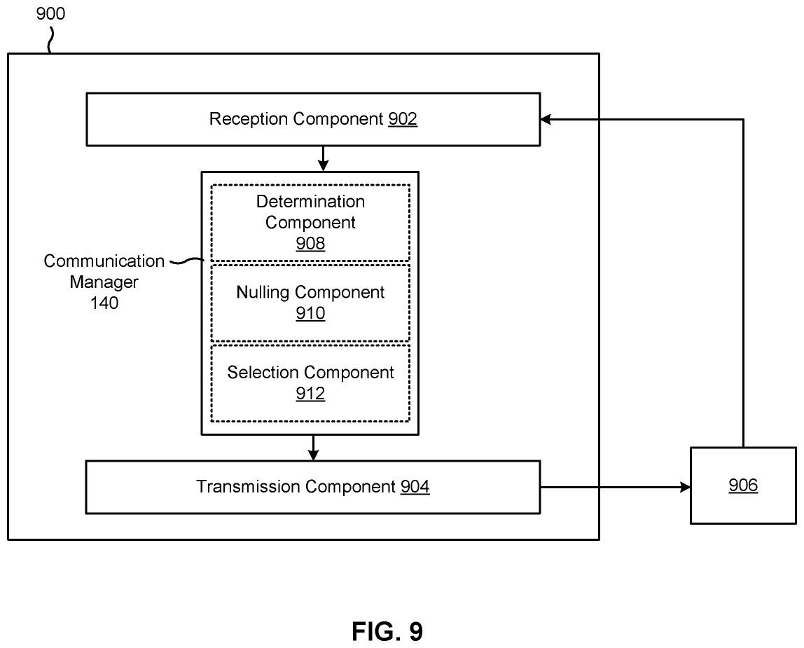

As shown in FIG. 7, in some aspects, process 700 may include determining at least one of a channel between the first mobile station and a second mobile station or a relative direction between the first mobile station and the second mobile station (block 710). For example, the first mobile station (e.g., using communication manager 140 and/or determination component 908, depicted in FIG. 9) may determine at least one of a channel between the first mobile station and a second mobile station or a relative direction between the first mobile station and the second mobile station, as described above.

As further shown in FIG. 7, in some aspects, process 700 may include applying nulling to a communication between the first mobile station and a base station based at least in part on the at least one of the channel between the first mobile station and the second mobile station or the relative direction between the first mobile station and the second mobile station (block 720). For example, the first mobile station (e.g., using communication manager 140 and/or nulling component 910, depicted in FIG. 9) may apply nulling to a communication between the first mobile station and a base station based at least in part on the at least one of the channel between the first mobile station and the second mobile station or the relative direction between the first mobile station and the second mobile station, as described above.

Process 700 may include additional aspects, such as any single aspect or any combination of aspects described below and/or in connection with one or more other processes described elsewhere herein.

In a first aspect, the communication is a downlink communication from the base station to the first mobile station, and applying nulling to the communication between the first mobile station and the base station includes applying Rx nulling during reception of the downlink communication from the base station to reduce interference on the downlink communication from an uplink transmission associated with the second mobile station.

In a second aspect, alone or in combination with the first aspect, determining the at least one of the channel between the first mobile station and the second mobile station or the relative direction between the first mobile station and the second mobile station includes estimating a channel from the second mobile station to the first mobile station.

In a third aspect, alone or in combination with one or more of the first and second aspects, process 700 includes receiving, from the base station, an indication of a configuration of an uplink reference signal associated with the second mobile station, and estimating the channel from the second mobile station to the first mobile station includes estimating the channel from the second mobile station to the first mobile station from a transmission of the uplink reference signal by the second mobile station based at least in part on the indication of the configuration of the uplink reference signal.

In a fourth aspect, alone or in combination with one or more of the first through third aspects, the uplink reference signal is a DMRS, an SRS, or a cross-link interference SRS.

In a fifth aspect, alone or in combination with one or more of the first through fourth aspects, estimating a channel from the second mobile station to the first mobile station includes estimating the channel from the second mobile station to the first mobile station when the second mobile station is transmitting an uplink communication to the base station.

In a sixth aspect, alone or in combination with one or more of the first through fifth aspects, process 700 includes transmitting, to the base station, an indication of the channel from the second mobile station to the first mobile station, and receiving, from the base station, an indication of one or more combiner parameters based at least in part on transmitting the indication of the channel from the second mobile station to the first mobile station, wherein applying Rx nulling during reception of the downlink communication from the base station includes applying Rx nulling during reception of the downlink communication using the one or more combiner parameters received from the base station.

In a seventh aspect, alone or in combination with one or more of the first through sixth aspects, process 700 includes transmitting, to the base station, an indication of the channel from the second mobile station to the first mobile station, and receiving, from the base station, an indication to use Rx nulling, and applying Rx nulling during the reception of the downlink communication includes applying Rx nulling during the reception of the downlink communication based at least in part on receiving the indication to use Rx nulling.

In an eighth aspect, alone or in combination with one or more of the first through seventh aspects, process 700 includes selecting, based at least in part on the channel from the second mobile station to the first mobile station, one or more combiner parameters to reduce interference on the downlink communication from an uplink communication transmitted by the second mobile station, and applying Rx nulling during reception of the downlink communication from the base station includes applying Rx nulling during reception of the downlink communication using the one or more combiner parameters.

In a ninth aspect, alone or in combination with one or more of the first through eighth aspects, the communication is an uplink communication from the first mobile station to the base station, and applying nulling to the communication between the first mobile station and the base station includes applying Tx nulling to transmission of the uplink communication to the base station to reduce interference from the uplink communication on a downlink communication from the base station to the second mobile station.

In a tenth aspect, alone or in combination with one or more of the first through ninth aspects, determining the at least one of the channel between the first mobile station and the second mobile station or the relative direction between the first mobile station and the second mobile station includes determining a channel from the first mobile station to the second mobile station.

In an eleventh aspect, alone or in combination with one or more of the first through tenth aspects, process 700 includes receiving, from the base station, an indication of a configuration of an uplink reference signal associated with the second mobile station, and determining the channel from the first mobile station to the second mobile station includes estimating a channel from the second mobile station to the first mobile station from a transmission of the uplink reference signal by the second mobile station, and estimating the channel from the first mobile station to the second mobile station based at least in part on the channel from the second mobile station to the first mobile station and channel reciprocity between the first mobile station and the second mobile station.

In a twelfth aspect, alone or in combination with one or more of the first through eleventh aspects, determining the channel from the first mobile station to the second mobile station includes receiving, from at least one of the second mobile station or the base station, an indication of the channel from the first mobile station to the second mobile station.

In a thirteenth aspect, alone or in combination with one or more of the first through twelfth aspects, process 700 includes receiving, from the base station, an indication of a precoder to be used by the first mobile station for the uplink communication, and applying Tx nulling to the transmission of the uplink communication includes applying Tx nulling to the transmission of the uplink communication using the precoder indicated in the indication received from the base station.

In a fourteenth aspect, alone or in combination with one or more of the first through thirteenth aspects, process 700 includes transmitting, to the base station, an indication of the channel from the first mobile station to the second mobile station, and receiving the indication of the precoder is based at least in part on transmitting the indication of the channel.

In a fifteenth aspect, alone or in combination with one or more of the first through fourteenth aspects, process 700 includes receiving, from the base station, an indication to use Tx nulling, and applying Tx nulling to the transmission of the uplink communication includes applying Tx nulling to the transmission of the uplink communication based at least in part on receiving the indication to use Tx nulling.

In a sixteenth aspect, alone or in combination with one or more of the first through fifteenth aspects, process 700 includes selecting a precoder for the uplink communication to reduce transmission power on the channel from the first mobile station to the second mobile station, and applying Tx nulling to the transmission of the uplink communication includes applying Tx nulling to the transmission of the uplink communication using the precoder.

In a seventeenth aspect, alone or in combination with one or more of the first through sixteenth aspects, the determining at least one of a channel between the first mobile station and a second mobile station or a relative direction between the first mobile station and the second mobile station includes determining the relative direction between the first mobile station and the second mobile station, and applying nulling to a communication between the first mobile station and a base station includes applying spatial nulling to the communication between the first mobile station and the base station based at least in part on the relative direction between the first mobile station and the second mobile station.

In an eighteenth aspect, alone or in combination with one or more of the first through seventeenth aspects, process 700 includes receiving, from the base station, an indication of configuration of a positioning reference signal associated with the second mobile station, and determining the relative direction between the first mobile station and the second mobile station includes detecting the relative direction between the first mobile station and the second mobile station based at least in part on the positioning reference signal associated with the second mobile station.

In a nineteenth aspect, alone or in combination with one or more of the first through eighteenth aspects, determining the relative direction between the first mobile station and the second mobile station includes detecting a location of the second mobile station using sidelink positioning.

In a twentieth aspect, alone or in combination with one or more of the first through nineteenth aspects, determining the relative direction between the first mobile station and the second mobile station includes receiving, from the base station, an indication of the relative direction between the first mobile station and the second mobile station.

In a twenty-first aspect, alone or in combination with one or more of the first through twentieth aspects, determining the relative direction between the first mobile station and the second mobile station includes estimating a direction of interference from a signal transmitted by the second mobile station.

In a twenty-second aspect, alone or in combination with one or more of the first through twenty-first aspects, determining the relative direction between the first mobile station and the second mobile station includes receiving, from the second mobile station via a sidelink channel, an indication of a location of the second mobile station.

In a twenty-third aspect, alone or in combination with one or more of the first through twenty-second aspects, process 700 includes receiving, from the base station, an indication to use spatial nulling, and applying spatial nulling to the communication between the first mobile station and the base station includes applying spatial nulling to the communication between the first mobile station and the base station based at least in part on receiving the indication to use spatial nulling.

In a twenty-fourth aspect, alone or in combination with one or more of the first through twenty-third aspects, the communication is a downlink communication, and applying spatial nulling to the communication between the first mobile station and the base station includes applying spatial nulling to reception of the downlink communication from the base station based at least in part on the relative direction between the first mobile station and the second mobile station to reduce interference on the downlink communication from an uplink transmission by the second mobile station.

In a twenty-fifth aspect, alone or in combination with one or more of the first through twenty-fourth aspects, the communication is an uplink communication, and applying spatial nulling to the communication between the first mobile station and the base station includes applying spatial nulling to transmission of the uplink communication to the base station based at least in part on the relative direction between the first mobile station and the second mobile station to reduce interference from the uplink communication on a downlink communication to the second mobile station.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with nulling for inter-UE interference cancellation.

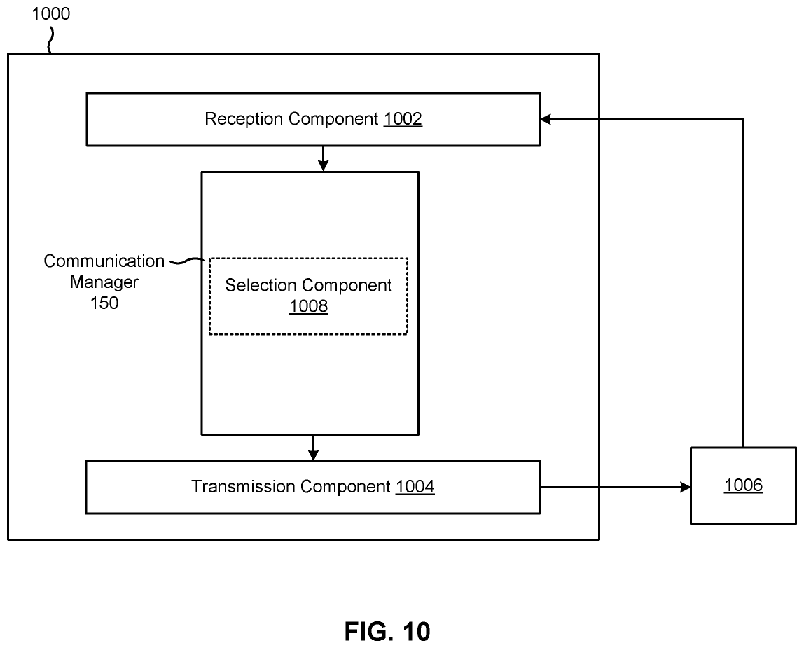

As shown in FIG. 8, in some aspects, process 800 may include transmitting, to a first mobile station, information relating to at least one of a channel between the first mobile station and a second mobile station or a relative direction between the first mobile station and the second mobile station (block 810). For example, the base station (e.g., using communication manager 150 and/or transmission component 1004, depicted in FIG. 10) may transmit, to a first mobile station, information relating to at least one of a channel between the first mobile station and a second mobile station or a relative direction between the first mobile station and the second mobile station, as described above.

As further shown in FIG. 8, in some aspects, process 800 may include transmitting, to the first mobile station, an indication of whether to apply nulling to a communication between the first mobile station and the base station based at least in part on the at least one of the channel between the first mobile station and the second mobile station or the relative direction between the first mobile station and the second mobile station (block 820). For example, the base station (e.g., using communication manager 150 and/or transmission component 1004, depicted in FIG. 10) may transmit, to the first mobile station, an indication of whether to apply nulling to a communication between the first mobile station and the base station based at least in part on the at least one of the channel between the first mobile station and the second mobile station or the relative direction between the first mobile station and the second mobile station, as described above.

Process 800 may include additional aspects, such as any single aspect or any combination of aspects described below and/or in connection with one or more other processes described elsewhere herein.

In a first aspect, the communication is a downlink communication from the base station to the first mobile station, and transmitting the indication includes transmitting, to the first mobile station, an indication to apply Rx nulling during reception of the downlink communication from the base station.

In a second aspect, alone or in combination with the first aspect, transmitting the information relating to the at least one of the channel between the first mobile station and the second mobile station or the relative direction between the first mobile station and the second mobile station includes transmitting, to the first mobile station, an indication of a configuration of an uplink reference signal associated with the second mobile station.

In a third aspect, alone or in combination with one or more of the first and second aspects, the uplink reference signal is a DMRS, an SRS, or a cross-link interference SRS.

In a fourth aspect, alone or in combination with one or more of the first through third aspects, process 800 includes receiving, from the first mobile station, an indication of a channel from the second mobile station to the first mobile station, and transmitting, to the first mobile station, an indication of one or more combiner parameters for Rx nulling based at least in part on the indication of the channel from the second mobile station to the first mobile station.

In a fifth aspect, alone or in combination with one or more of the first through fourth aspects, process 800 includes receiving, from the first mobile station, an indication of a channel from the second mobile station to the first mobile station, and transmitting the indication to apply Rx nulling during the reception of the downlink communication is based at least in part on the indication of the channel from the second mobile station to the first mobile station.

In a sixth aspect, alone or in combination with one or more of the first through fifth aspects, the communication is an uplink communication from the first mobile station to the base station, and transmitting the indication includes transmitting, to the first mobile station, an indication to apply Tx nulling to transmission of the uplink communication to the base station.

In a seventh aspect, alone or in combination with one or more of the first through sixth aspects, transmitting the information relating to the at least one of the channel between the first mobile station and the second mobile station or the relative direction between the first mobile station and the second mobile station includes transmitting, to the first mobile station, an indication of a configuration of an uplink reference signal associated with the second mobile station.

In an eighth aspect, alone or in combination with one or more of the first through seventh aspects, transmitting the information relating to the at least one of the channel between the first mobile station and the second mobile station or the relative direction between the first mobile station and the second mobile station includes transmitting, to the first mobile station, an indication of the channel from the first mobile station to the second mobile station.

In a ninth aspect, alone or in combination with one or more of the first through eighth aspects, process 800 includes receiving, from at least one of the first mobile station or the second mobile station, an indication of the channel from the first mobile station to the second mobile station, and transmitting, to the first mobile station, an indication of a precoder for Tx nulling based at least in part on the indication of the channel from the first mobile station to the second mobile station.

In a tenth aspect, alone or in combination with one or more of the first through ninth aspects, process 800 includes receiving, from at least one of the first mobile station or the second mobile station, an indication of the channel from the first mobile station to the second mobile station, and transmitting the indication to apply Tx nulling to the transmission of the uplink communication is based at least in part on the indication of the channel from the first mobile station to the second mobile station.

In an eleventh aspect, alone or in combination with one or more of the first through tenth aspects, the transmitting the indication includes transmitting, to the first mobile station, an indication to apply spatial nulling to the communication between the first mobile station and the base station based at least in part on the relative direction between the first mobile station and the second mobile station.

In a twelfth aspect, alone or in combination with one or more of the first through eleventh aspects, transmitting the information relating to the at least one of the channel between the first mobile station and the second mobile station or the relative direction between the first mobile station and the second mobile station includes transmitting, to the first mobile station, an indication of configuration of a positioning reference signal associated with the second mobile station.

In a thirteenth aspect, alone or in combination with one or more of the first through twelfth aspects, transmitting the information relating to the at least one of the channel between the first mobile station and the second mobile station or the relative direction between the first mobile station and the second mobile station includes transmitting, to the first mobile station, an indication of the relative direction between the first mobile station and the second mobile station.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a first mobile station, or a first mobile station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a determination component 908, a nulling component 910, and/or a selection component 912, among other examples.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the first mobile station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the first mobile station described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the first mobile station described in connection with FIG. 2. In some aspects, the transmission component 904 may be co-located with the reception component 902 in a transceiver.

The determination component 908 may determine at least one of a channel between the first mobile station and a second mobile station or a relative direction between the first mobile station and the second mobile station. The nulling component 910 may apply nulling to a communication between the first mobile station and a base station based at least in part on the at least one of the channel between the first mobile station and the second mobile station or the relative direction between the first mobile station and the second mobile station.

The reception component 902 may receive, from the base station, an indication of a configuration of an uplink reference signal associated with the second mobile station, wherein estimating the channel from the second mobile station to the first mobile station comprises estimating the channel from the second mobile station to the first mobile station from a transmission of the uplink reference signal by the second mobile station based at least in part on the indication of the configuration of the uplink reference signal.

The transmission component 904 may transmit, to the base station, an indication of the channel from the second mobile station to the first mobile station.

The reception component 902 may receive, from the base station, an indication of one or more combiner parameters based at least in part on transmitting the indication of the channel from the second mobile station to the first mobile station, wherein applying Rx nulling during reception of the downlink communication from the base station comprises applying Rx nulling during reception of the downlink communication using the one or more combiner parameters received from the base station.

The transmission component 904 may transmit, to the base station, an indication of the channel from the second mobile station to the first mobile station.

The reception component 902 may receive, from the base station, an indication to use Rx nulling, wherein applying Rx nulling during the reception of the downlink communication comprises applying Rx nulling during the reception of the downlink communication based at least in part on receiving the indication to use Rx nulling.

The selection component 912 may select, based at least in part on the channel from the second mobile station to the first mobile station, one or more combiner parameters to reduce interference on the downlink communication from an uplink communication transmitted by the second mobile station, wherein applying Rx nulling during reception of the downlink communication from the base station comprises applying Rx nulling during reception of the downlink communication using the one or more combiner parameters.

The reception component 902 may receive, from the base station, an indication of a configuration of an uplink reference signal associated with the second mobile station, wherein determining the channel from the first mobile station to the second mobile station comprises estimating a channel from the second mobile station to the first mobile station from a transmission of the uplink reference signal by the second mobile station; and estimating the channel from the first mobile station to the second mobile station based at least in part on the channel from the second mobile station to the first mobile station and channel reciprocity between the first mobile station and the second mobile station.

The reception component 902 may receive, from the base station, an indication of a precoder to be used by the first mobile station for the uplink communication, wherein applying Tx nulling to the transmission of the uplink communication comprises applying Tx nulling to the transmission of the uplink communication using the precoder indicated in the indication received from the base station.

The transmission component 904 may transmit, to the base station, an indication of the channel from the first mobile station to the second mobile station, wherein receiving the indication of the precoder is based at least in part on transmitting the indication of the channel.

The reception component 902 may receive, from the base station, an indication to use Tx nulling, wherein applying Tx nulling to the transmission of the uplink communication comprises applying Tx nulling to the transmission of the uplink communication based at least in part on receiving the indication to use Tx nulling.

The selection component 912 may select a precoder for the uplink communication to reduce transmission power on the channel from the first mobile station to the second mobile station, wherein applying Tx nulling to the transmission of the uplink communication comprises applying Tx nulling to the transmission of the uplink communication using the precoder.

The reception component 902 may receive, from the base station, an indication of configuration of a positioning reference signal associated with the second mobile station, wherein determining the relative direction between the first mobile station and the second mobile station comprises detecting the relative direction between the first mobile station and the second mobile station based at least in part on the positioning reference signal associated with the second mobile station.

The reception component 902 may receive, from the base station, an indication to use spatial nulling, wherein applying spatial nulling to the communication between the first mobile station and the base station comprises applying spatial nulling to the communication between the first mobile station and the base station based at least in part on receiving the indication to use spatial nulling.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a selection component 1008.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The transmission component 1004 may transmit, to a first mobile station, information relating to at least one of a channel between the first mobile station and a second mobile station or a relative direction between the first mobile station and the second mobile station. The transmission component 1004 may transmit, to the first mobile station, an indication of whether to apply nulling to a communication between the first mobile station and the base station based at least in part on the at least one of the channel between the first mobile station and the second mobile station or the relative direction between the first mobile station and the second mobile station. The selection component 1008 may select whether the first mobile station is to apply nulling to the communication between the first mobile station and the base station.

The reception component 1002 may receive, from the first mobile station, an indication of a channel from the second mobile station to the first mobile station.

The transmission component 1004 may transmit, to the first mobile station, an indication of one or more combiner parameters for Rx nulling based at least in part on the indication of the channel from the second mobile station to the first mobile station.

The reception component 1002 may receive, from the first mobile station, an indication of a channel from the second mobile station to the first mobile station, wherein transmitting the indication to apply Rx nulling during the reception of the downlink communication is based at least in part on the indication of the channel from the second mobile station to the first mobile station.

The reception component 1002 may receive, from at least one of the first mobile station or the second mobile station, an indication of the channel from the first mobile station to the second mobile station.

The transmission component 1004 may transmit, to the first mobile station, an indication of a precoder for Tx nulling based at least in part on the indication of the channel from the first mobile station to the second mobile station.

The reception component 1002 may receive, from at least one of the first mobile station or the second mobile station, an indication of the channel from the first mobile station to the second mobile station, wherein transmitting the indication to apply Tx nulling to the transmission of the uplink communication is based at least in part on the indication of the channel from the first mobile station to the second mobile station.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first mobile station, comprising: determining, by the first mobile station, at least one of a channel between the first mobile station and a second mobile station or a relative direction between the first mobile station and the second mobile station; and applying, by the first mobile station, nulling to a communication between the first mobile station and a base station based at least in part on the at least one of the channel between the first mobile station and the second mobile station or the relative direction between the first mobile station and the second mobile station.

Aspect 2: The method of Aspect 1, wherein the communication is a downlink communication from the base station to the first mobile station, and wherein applying nulling to the communication between the first mobile station and the base station comprises: applying receive (Rx) nulling during reception of the downlink communication from the base station to reduce interference on the downlink communication from an uplink transmission associated with the second mobile station.

Aspect 3: The method of Aspect 2, wherein determining the at least one of the channel between the first mobile station and the second mobile station or the relative direction between the first mobile station and the second mobile station comprises: estimating a channel from the second mobile station to the first mobile station.

Aspect 4: The method of Aspect 3, further comprising receiving, from the base station, an indication of a configuration of an uplink reference signal associated with the second mobile station, wherein estimating the channel from the second mobile station to the first mobile station comprises: estimating the channel from the second mobile station to the first mobile station from a transmission of the uplink reference signal by the second mobile station based at least in part on the indication of the configuration of the uplink reference signal.

Aspect 5: The method of Aspect 4, wherein the uplink reference signal is a demodulation reference signal (DMRS), a sounding reference signal (SRS), or a cross-link interference SRS.

Aspect 6: The method of any of Aspects 3-5, wherein estimating the channel from the second mobile station to the first mobile station comprises: estimating the channel from the second mobile station to the first mobile station when the second mobile station is transmitting an uplink communication to the base station.

Aspect 7: The method of any of Aspects 3-6, further comprising: transmitting, to the base station, an indication of the channel from the second mobile station to the first mobile station; and receiving, from the base station, an indication of one or more combiner parameters based at least in part on transmitting the indication of the channel from the second mobile station to the first mobile station, wherein applying Rx nulling during reception of the downlink communication from the base station comprises applying Rx nulling during reception of the downlink communication using the one or more combiner parameters received from the base station.

Aspect 8: The method of any of Aspects 3-7, further comprising: transmitting, to the base station, an indication of the channel from the second mobile station to the first mobile station; and receiving, from the base station, an indication to use Rx nulling, wherein applying Rx nulling during the reception of the downlink communication comprises applying Rx nulling during the reception of the downlink communication based at least in part on receiving the indication to use Rx nulling.

Aspect 9: The method of any of Aspects 3-6 and 8, further comprising: selecting, based at least in part on the channel from the second mobile station to the first mobile station, one or more combiner parameters to reduce interference on the downlink communication from an uplink communication transmitted by the second mobile station, wherein applying Rx nulling during reception of the downlink communication from the base station comprises applying Rx nulling during reception of the downlink communication using the one or more combiner parameters.

Aspect 10: The method of Aspect 1, wherein the communication is an uplink communication from the first mobile station to the base station, and wherein applying nulling to the communication between the first mobile station and the base station comprises: applying transmit (Tx) nulling to transmission of the uplink communication to the base station to reduce interference from the uplink communication on a downlink communication from the base station to the second mobile station.

Aspect 11: The method of Aspect 10, wherein determining the at least one of the channel between the first mobile station and the second mobile station or the relative direction between the first mobile station and the second mobile station comprises: determining a channel from the first mobile station to the second mobile station.

Aspect 12: The method of Aspect 11, further comprising receiving, from the base station, an indication of a configuration of an uplink reference signal associated with the second mobile station, wherein determining the channel from the first mobile station to the second mobile station comprises: estimating a channel from the second mobile station to the first mobile station from a transmission of the uplink reference signal by the second mobile station; and estimating the channel from the first mobile station to the second mobile station based at least in part on the channel from the second mobile station to the first mobile station and channel reciprocity between the first mobile station and the second mobile station.

Aspect 13: The method of Aspect 11, wherein determining the channel from the first mobile station to the second mobile station comprises: receiving, from at least one of the second mobile station or the base station, an indication of the channel from the first mobile station to the second mobile station.

Aspect 14: The method of any of Aspects 11-13, further comprising: receiving, from the base station, an indication of a precoder to be used by the first mobile station for the uplink communication, wherein applying Tx nulling to the transmission of the uplink communication comprises applying Tx nulling to the transmission of the uplink communication using the precoder indicated in the indication received from the base station.

Aspect 15: The method of Aspect 14, further comprising: transmitting, to the base station, an indication of the channel from the first mobile station to the second mobile station, wherein receiving the indication of the precoder is based at least in part on transmitting the indication of the channel.

Aspect 16: The method of any of Aspects 11-15, further comprising: receiving, from the base station, an indication to use Tx nulling, wherein applying Tx nulling to the transmission of the uplink communication comprises applying Tx nulling to the transmission of the uplink communication based at least in part on receiving the indication to use Tx nulling.

Aspect 17: The method of any of Aspects 11-13 and 16, further comprising: selecting a precoder for the uplink communication to reduce transmission power on the channel from the first mobile station to the second mobile station, wherein applying Tx nulling to the transmission of the uplink communication comprises applying Tx nulling to the transmission of the uplink communication using the precoder.

Aspect 18: The method of Aspect 1, wherein determining the at least one of the channel between the first mobile station and the second mobile station or the relative direction between the first mobile station and the second mobile station comprises determining the relative direction between the first mobile station and the second mobile station, and wherein applying nulling to the communication between the first mobile station and the base station comprises: applying spatial nulling to the communication between the first mobile station and the base station based at least in part on the relative direction between the first mobile station and the second mobile station.

Aspect 19: The method of Aspect 18, further comprising: receiving, from the base station, an indication of configuration of a positioning reference signal associated with the second mobile station, wherein determining the relative direction between the first mobile station and the second mobile station comprises detecting the relative direction between the first mobile station and the second mobile station based at least in part on the positioning reference signal associated with the second mobile station.

Aspect 20: The method of Aspect 18, wherein determining the relative direction between the first mobile station and the second mobile station comprises: detecting a location of the second mobile station using sidelink positioning.

Aspect 21: The method of Aspect 18, wherein determining the relative direction between the first mobile station and the second mobile station comprises: receiving, from the base station, an indication of the relative direction between the first mobile station and the second mobile station.

Aspect 22: The method of Aspect 18, wherein determining the relative direction between the first mobile station and the second mobile station comprises: estimating a direction of interference from a signal transmitted by the second mobile station.

Aspect 23: The method of Aspect 18, wherein determining the relative direction between the first mobile station and the second mobile station comprises: receiving, from the second mobile station via a sidelink channel, an indication of a location of the second mobile station.

Aspect 24: The method of any of Aspects 18-23, further comprising: receiving, from the base station, an indication to use spatial nulling, wherein applying spatial nulling to the communication between the first mobile station and the base station comprises applying spatial nulling to the communication between the first mobile station and the base station based at least in part on receiving the indication to use spatial nulling.

Aspect 25: The method of any of Aspects 18-24, wherein the communication is a downlink communication, and wherein applying spatial nulling to the communication between the first mobile station and the base station comprises: applying spatial nulling to reception of the downlink communication from the base station based at least in part on the relative direction between the first mobile station and the second mobile station to reduce interference on the downlink communication from an uplink transmission by the second mobile station.

Aspect 26: The method of any of Aspects 18-24, wherein the communication is an uplink communication, and wherein applying spatial nulling to the communication between the first mobile station and the base station comprises: applying spatial nulling to transmission of the uplink communication to the base station based at least in part on the relative direction between the first mobile station and the second mobile station to reduce interference from the uplink communication on a downlink communication to the second mobile station.

Aspect 27: A method of wireless communication performed by a base station, comprising: transmitting, by the base station and to a first mobile station, information relating to at least one of a channel between the first mobile station and a second mobile station or a relative direction between the first mobile station and the second mobile station; and transmitting, by the base station and to the first mobile station, an indication of whether to apply nulling to a communication between the first mobile station and the base station based at least in part on the at least one of the channel between the first mobile station and the second mobile station or the relative direction between the first mobile station and the second mobile station.

Aspect 28: The method of Aspect 27, wherein the communication is a downlink communication from the base station to the first mobile station, and wherein transmitting the indication comprises: transmitting, to the first mobile station, an indication to apply receive (Rx) nulling during reception of the downlink communication from the base station.

Aspect 29: The method of Aspect 28, wherein transmitting the information relating to the at least one of the channel between the first mobile station and the second mobile station or the relative direction between the first mobile station and the second mobile station comprises: transmitting, to the first mobile station, an indication of a configuration of an uplink reference signal associated with the second mobile station.

Aspect 30: The method of Aspect 29, wherein the uplink reference signal is a demodulation reference signal (DMRS), a sounding reference signal (SRS), or a cross-link interference SRS.

Aspect 31: The method of any of Aspects 28-30, further comprising: receiving, from the first mobile station, an indication of a channel from the second mobile station to the first mobile station; and transmitting, to the first mobile station, an indication of one or more combiner parameters for Rx nulling based at least in part on the indication of the channel from the second mobile station to the first mobile station.

Aspect 32: The method of any of Aspects 28-31, further comprising: receiving, from the first mobile station, an indication of a channel from the second mobile station to the first mobile station, wherein transmitting the indication to apply Rx nulling during the reception of the downlink communication is based at least in part on the indication of the channel from the second mobile station to the first mobile station.

Aspect 33: The method of Aspect 27, wherein the communication is an uplink communication from the first mobile station to the base station, and wherein transmitting the indication comprises: transmitting, to the first mobile station, an indication to apply transmit (Tx) nulling to transmission of the uplink communication to the base station.

Aspect 34: The method of Aspect 33, wherein transmitting the information relating to the at least one of the channel between the first mobile station and the second mobile station or the relative direction between the first mobile station and the second mobile station comprises: transmitting, to the first mobile station, an indication of a configuration of an uplink reference signal associated with the second mobile station.

Aspect 35: The method of Aspect 33, wherein transmitting the information relating to the at least one of the channel between the first mobile station and the second mobile station or the relative direction between the first mobile station and the second mobile station comprises: transmitting, to the first mobile station, an indication of the channel from the first mobile station to the second mobile station.

Aspect 36: The method of any of Aspects 33-35, further comprising: receiving, from at least one of the first mobile station or the second mobile station, an indication of the channel from the first mobile station to the second mobile station; and transmitting, to the first mobile station, an indication of a precoder for Tx nulling based at least in part on the indication of the channel from the first mobile station to the second mobile station.

Aspect 37: The method of any of Aspects 33-36, further comprising: receiving, from at least one of the first mobile station or the second mobile station, an indication of the channel from the first mobile station to the second mobile station, wherein transmitting the indication to apply Tx nulling to the transmission of the uplink communication is based at least in part on the indication of the channel from the first mobile station to the second mobile station.

Aspect 38: The method of Aspect 27, wherein the transmitting the indication comprises: transmitting, to the first mobile station, an indication to apply spatial nulling to the communication between the first mobile station and the base station based at least in part on the relative direction between the first mobile station and the second mobile station.

Aspect 39: The method of Aspect 38, wherein transmitting the information relating to the at least one of the channel between the first mobile station and the second mobile station or the relative direction between the first mobile station and the second mobile station comprises: transmitting, to the first mobile station, an indication of configuration of a positioning reference signal associated with the second mobile station.

Aspect 40: The method of Aspect 38, wherein transmitting the information relating to the at least one of the channel between the first mobile station and the second mobile station or the relative direction between the first mobile station and the second mobile station comprises: transmitting, to the first mobile station, an indication of the relative direction between the first mobile station and the second mobile station.

Aspect 41: An apparatus for wireless communication at a device, comprising a processor; memory coupled with the processor; and instructions stored in the memory and executable by the processor to cause the apparatus to perform the method of one or more of Aspects 1-26.

Aspect 42: A device for wireless communication, comprising a memory and one or more processors coupled to the memory, the one or more processors configured to perform the method of one or more of Aspects 1-26.

Aspect 43: An apparatus for wireless communication, comprising at least one means for performing the method of one or more of Aspects 1-26.

Aspect 44: A non-transitory computer-readable medium storing code for wireless communication, the code comprising instructions executable by a processor to perform the method of one or more of Aspects 1-26.

Aspect 45: A non-transitory computer-readable medium storing a set of instructions for wireless communication, the set of instructions comprising one or more instructions that, when executed by one or more processors of a device, cause the device to perform the method of one or more of Aspects 1-26.

Aspect 46: An apparatus for wireless communication at a device, comprising a processor; memory coupled with the processor; and instructions stored in the memory and executable by the processor to cause the apparatus to perform the method of one or more of Aspects 27-40.

Aspect 47: A device for wireless communication, comprising a memory and one or more processors coupled to the memory, the one or more processors configured to perform the method of one or more of Aspects 27-40.

Aspect 48: An apparatus for wireless communication, comprising at least one means for performing the method of one or more of Aspects 27-40.

Aspect 49: A non-transitory computer-readable medium storing code for wireless communication, the code comprising instructions executable by a processor to perform the method of one or more of Aspects 27-40.

Aspect 50: A non-transitory computer-readable medium storing a set of instructions for wireless communication, the set of instructions comprising one or more instructions that, when executed by one or more processors of a device, cause the device to perform the method of one or more of Aspects 27-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first mobile station for wireless communication, comprising:
a memory; and
one or more processors, coupled to the memory, configured to:
determine at least one of a channel between the first mobile station and a second mobile station or a relative direction between the first mobile station and the second mobile station; and
apply nulling to a communication between the first mobile station and a base station based at least in part on the at least one of the channel between the first mobile station and the second mobile station or the relative direction between the first mobile station and the second mobile station.

2. The first mobile station of claim 1, wherein the communication is a downlink communication from the base station to the first mobile station, and wherein the one or more processors, to apply nulling to the communication between the first mobile station and the base station, are configured to:
apply receive (Rx) nulling during reception of the downlink communication from the base station to reduce interference on the downlink communication from an uplink transmission associated with the second mobile station.

3. The first mobile station of claim 2, wherein the one or more processors, to determine the at least one of the channel between the first mobile station and the second mobile station or the relative direction between the first mobile station and the second mobile station, are configured to:
estimate a channel from the second mobile station to the first mobile station.

4. The first mobile station of claim 3, wherein the one or more processors are further configured to receive, from the base station, an indication of a configuration of an uplink reference signal associated with the second mobile station, and wherein the one or more processors, to estimate the channel from the second mobile station to the first mobile station, are configured to:
estimate the channel from the second mobile station to the first mobile station from a transmission of the uplink reference signal by the second mobile station based at least in part on the indication of the configuration of the uplink reference signal.

5. The first mobile station of claim 3, wherein the one or more processors, to estimate the channel from the second mobile station to the first mobile station, are configured to:
estimate the channel from the second mobile station to the first mobile station when the second mobile station is transmitting an uplink communication to the base station.

6. The first mobile station of claim 3, wherein the one or more processors are further configured to:
transmit, to the base station, an indication of the channel from the second mobile station to the first mobile station; and
receive, from the base station, an indication of one or more combiner parameters based at least in part on transmitting the indication of the channel from the second mobile station to the first mobile station, wherein the one or more processors, to apply Rx nulling during reception of the downlink communication from the base station, are configured to apply Rx nulling during reception of the downlink communication using the one or more combiner parameters received from the base station.

7. The first mobile station of claim 3, wherein the one or more processors are further configured to:
transmitting, to the base station, an indication of the channel from the second mobile station to the first mobile station; and
receiving, from the base station, an indication to use Rx nulling, wherein the one or more processors, to apply Rx nulling during the reception of the downlink communication, are configured to apply Rx nulling during the reception of the downlink communication based at least in part on receiving the indication to use Rx nulling.

8. The first mobile station of claim 3, wherein the one or more processors are further configured to:
select, based at least in part on the channel from the second mobile station to the first mobile station, one or more combiner parameters to reduce interference on the downlink communication from an uplink communication transmitted by the second mobile station, wherein the one or more processors, to apply Rx nulling during reception of the downlink communication from the base station, are configure to apply Rx nulling during reception of the downlink communication using the one or more combiner parameters.

9. The first mobile station of claim 1, wherein the communication is an uplink communication from the first mobile station to the base station, and wherein the one or more processors, to apply nulling to the communication between the first mobile station and the base station, are configured to:
apply transmit (Tx) nulling to transmission of the uplink communication to the base station to reduce interference from the uplink communication on a downlink communication from the base station to the second mobile station.

10. The first mobile station of claim 9, wherein the one or more processors, to determine the at least one of the channel between the first mobile station and the second mobile station or the relative direction between the first mobile station and the second mobile station, are configured to:
determine a channel from the first mobile station to the second mobile station.

11. The first mobile station of claim 10, wherein the one or more processors are further configured to receive, from the base station, an indication of a configuration of an uplink reference signal associated with the second mobile station, and wherein the one or more processors, to determine the channel from the first mobile station to the second mobile station, are configured to:
estimate a channel from the second mobile station to the first mobile station from a transmission of the uplink reference signal by the second mobile station; and
estimate the channel from the first mobile station to the second mobile station based at least in part on the channel from the second mobile station to the first mobile station and channel reciprocity between the first mobile station and the second mobile station.

12. The first mobile station of claim 10, wherein the one or more processors, to determine the channel from the first mobile station to the second mobile station, are configured to:
receive, from at least one of the second mobile station or the base station, an indication of the channel from the first mobile station to the second mobile station.

13. The first mobile station of claim 10, wherein the one or more processors are further configured to:
receive, from the base station, an indication of a precoder to be used by the first mobile station for the uplink communication, wherein the one or more processors, to apply Tx nulling to the transmission of the uplink communication, are configured to apply Tx nulling to the transmission of the uplink communication using the precoder indicated in the indication received from the base station.

14. The first mobile station of claim 13, wherein the one or more processors are further configured to:
transmit, to the base station, an indication of the channel from the first mobile station to the second mobile station, wherein the one or more processors, to receive the indication of the precoder, are configured to receive the indication of the precoder based at least in part on transmitting the indication of the channel.

15. The first mobile station of claim 10, wherein the one or more processors are further configured to:
receive, from the base station, an indication to use Tx nulling, wherein the one or more processors, to apply Tx nulling to the transmission of the uplink communication, are configured to apply Tx nulling to the transmission of the uplink communication based at least in part on receiving the indication to use Tx nulling.

16. The first mobile station of claim 10, wherein the one or more processors are further configured to:
select a precoder for the uplink communication to reduce transmission power on the channel from the first mobile station to the second mobile station, wherein the one or more processors, to apply Tx nulling to the transmission of the uplink communication, are configured to apply Tx nulling to the transmission of the uplink communication using the precoder.

17. The first mobile station of claim 1, wherein the one or more processors, to determine the at least one of the channel between the first mobile station and the second mobile station or the relative direction between the first mobile station and the second mobile station, are configured to determine the relative direction between the first mobile station and the second mobile station, and wherein the one or more processors, to apply nulling to the communication between the first mobile station and the base station, are configured to:
apply spatial nulling to the communication between the first mobile station and the base station based at least in part on the relative direction between the first mobile station and the second mobile station.

18. The first mobile station of claim 17, wherein the one or more processors are further configured to:
receive, from the base station, an indication of configuration of a positioning reference signal associated with the second mobile station, wherein the one or more processors, to determine the relative direction between the first mobile station and the second mobile station, are configured to detect the relative direction between the first mobile station and the second mobile station based at least in part on the positioning reference signal associated with the second mobile station.

19. The first mobile station of claim 17, wherein the one or more processors, to determine the relative direction between the first mobile station and the second mobile station, are configured to:
detect a location of the second mobile station using sidelink positioning.

20. The first mobile station of claim 17, wherein the one or more processors, to determine the relative direction between the first mobile station and the second mobile station, are configured to:
receive, from the base station, an indication of the relative direction between the first mobile station and the second mobile station.

21. The first mobile station of claim 17, wherein the one or more processors, to determine the relative direction between the first mobile station and the second mobile station, are configured to:
estimate a direction of interference from a signal transmitted by the second mobile station.

22. The first mobile station of claim 17, wherein the one or more processors, to determine the relative direction between the first mobile station and the second mobile station, are configured to:
receive, from the second mobile station via a sidelink channel, an indication of a location of the second mobile station.

23. The first mobile station of claim 17, wherein the one or more processors are further configured to:
receive, from the base station, an indication to use spatial nulling, wherein the one or more processors, to apply spatial nulling to the communication between the first mobile station and the base station, are configured to apply spatial nulling to the communication between the first mobile station and the base station based at least in part on receiving the indication to use spatial nulling.

24. A method of wireless communication performed by a first mobile station, comprising:
determining, by the first mobile station, at least one of a channel between the first mobile station and a second mobile station or a relative direction between the first mobile station and the second mobile station; and
applying, by the first mobile station, nulling to a communication between the first mobile station and a base station based at least in part on the at least one of the channel between the first mobile station and the second mobile station or the relative direction between the first mobile station and the second mobile station.

25. The method of claim 24, wherein the communication is a downlink communication from the base station to the first mobile station, wherein determining the at least one of the channel between the first mobile station and the second mobile station or the relative direction between the first mobile station and the second mobile station comprises estimating a channel from the second mobile station to the first mobile station, and wherein applying nulling to the communication between the first mobile station and the base station comprises:
applying receive (Rx) nulling during reception of the downlink communication from the base station to reduce interference on the downlink communication from an uplink transmission associated with the second mobile station.

26. The method of claim 25, further comprising receiving, from the base station, an indication of a configuration of an uplink reference signal associated with the second mobile station, wherein estimating the channel from the second mobile station to the first mobile station comprises:
estimating the channel from the second mobile station to the first mobile station from a transmission of the uplink reference signal by the second mobile station based at least in part on the indication of the configuration of the uplink reference signal.

27. The method of claim 24, wherein the communication is an uplink communication from the first mobile station to the base station, wherein determining the at least one of the channel between the first mobile station and the second mobile station or the relative direction between the first mobile station and the second mobile station comprises determining a channel from the first mobile station to the second mobile station, and wherein applying nulling to the communication between the first mobile station and the base station comprises:
applying transmit (Tx) nulling to transmission of the uplink communication to the base station to reduce interference from the uplink communication on a downlink communication from the base station to the second mobile station.

28. The method of claim 24, wherein determining the at least one of the channel between the first mobile station and the second mobile station or the relative direction between the first mobile station and the second mobile station comprises determining the relative direction between the first mobile station and the second mobile station, and wherein applying nulling to the communication between the first mobile station and the base station comprises:
applying spatial nulling to the communication between the first mobile station and the base station based at least in part on the relative direction between the first mobile station and the second mobile station.

29. A non-transitory computer-readable medium storing a set of instructions for wireless communication, the set of instructions comprising:
one or more instructions that, when executed by one or more processors of a first mobile station, cause the first mobile station to:
determine at least one of a channel between the first mobile station and a second mobile station or a relative direction between the first mobile station and the second mobile station; and
apply nulling to a communication between the first mobile station and a base station based at least in part on the at least one of the channel between the first mobile station and the second mobile station or the relative direction between the first mobile station and the second mobile station.

30. An apparatus for wireless communication, comprising:
means for determining at least one of a channel between the apparatus and a mobile station or a relative direction between the apparatus and the mobile station; and
means for applying nulling to a communication between the apparatus and a base station based at least in part on the at least one of the channel between the apparatus and the mobile station or the relative direction between the apparatus and the mobile station.
